(19) United States
(12) Patent Application Publication
(10) Pub. No.: US 2026/0120053 A1
(43) Pub. Date: Apr. 30, 2026

(54) METHODS, SYSTEMS, AND DEVICES FOR BEVERAGE CONSUMPTION AND INVENTORY CONTROL AND TRACKING

(71) Applicant: Aware Technologies, Inc., Dover, DE (US)

(72) Inventors: Vince Anido, Carrollton, GA (US); Justin Park, Carrollton, GA (US); Kathryn Browning, Carrollton, GA (US)

(21) Appl. No.: 19/432,072

(22) Filed: Dec. 23, 2025

Related U.S. Application Data
(63) Continuation-in-part of application No. 18/396,912, filed on Dec. 27, 2023, now abandoned.
Application No. 18/396,912 is a continuation of application No. 17/322,024, filed on May 17, 2021, now Pat. No. 11,861,557.
Application No. 17/322,024 is a continuation of application No. 16/671,534, filed on Nov. 1, 2019, now Pat. No. 11,010,713.
(60) Provisional application No. 62/755,934, filed on Nov. 5, 2018.

(51) Int. Cl. G06Q 10/087; G06Q 50/12

(52) U.S. Cl. CPC G06Q 10/087; B67D 2210/00065; B67D 2210/00081; B67D 2210/00091; G06Q 50/12

(57) ABSTRACT

A method for authenticating physical products using dual-frequency radio frequency identification tags includes receiving tag data from a consumer device that scanned a dual-frequency RFID tag supporting near field communication and/or ultra-high frequency protocols. The system extracts a unique tag identifier and cryptographic signature data from the received tag data, and validates tag authenticity by comparing the cryptographic signature data against stored cryptographic keys associated with the unique tag identifier. The method determines tamper status by analyzing tamper detection circuitry integrated within the tag. The system retrieves product metadata from a secure database and generates a personalized product information response based on the retrieved metadata and consumer interaction history. The personalized response is transmitted to the consumer device for display. The system may process product claiming requests, manage ownership records in an immutable cryptographic ledger, and support manufacturing integration through flexible tag association.

### RELATED APPLICATIONS

This application is a Continuation-in-Part of U.S. application Ser. No. 18/396,912 filed on Dec. 27, 2023, which in turn is a Continuation of U.S. application Ser. No. 17/322,024 filed on May 17, 2021, which issued on Jan. 2, 2024 as U.S. Pat. No. 11,861,557, which is a Continuation of U.S. application Ser. No. 16/671,534 filed on Nov. 1, 2019, which issued on May 18, 2021 as U.S. Pat. No. 11,010,713, which claims the benefit of priority to U.S. Provisional Application No. 62/755,934 filed on Nov. 5, 2018, all of which are hereby incorporated by reference herein in their entirety.

It is intended that the above-referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to tracking the amount of liquid being poured from a pour spout. More particularly, the present disclosure relates to systems and methods for automated inventory control of dispensed liquids using inventory tracking devices in operative communication with a processing unit over a network infrastructure.

### BACKGROUND

In the dispensing of liquids, particularly alcoholic beverages, it is customary to use pouring spouts mounted on the tops of bottles to facilitate the dispensing with minimum spillage. In general, these pouring spouts are free-flow pouring devices (i.e., the liquid continues to flow from the bottle so long as the bottle remains tilted. Customarily, the liquid is dispensed into a measuring vessel of fixed volume, as for example: ½ oz, ⅓ oz, 1 oz, 1½ oz, etc. and, when the desired volume is reached in the measuring vessel, the bottle is tilted to its upright non-pouring position. The contents of the measuring vessel, typically, is then emptied into a serving glass thereafter, or the like.

This procedure of pouring the liquid from the bottle to a measuring container and thence to the glass or other vessel (in which the beverage is to be served or mixed) is sometimes a tedious and time consuming process - especially in the case where many beverages are to be dispensed in a short period of time. Consequently, in the press of business, a bartender may resort to sight measuring the amount of beverage directly into the glass or mixing container, thereby eliminating the intermediate step of pouring the beverage first into a measuring container. Because of variations in the size and shape of glasses and mixing containers, the amount and size of ice cubes and the like which may be present in the container, and other factors, sight-measuring is at best a haphazard measuring procedure.

To preserve the speed of pouring by sight-measure, many pouring devices have been made which themselves combine the pouring function and the measuring function so that as the pouring operation proceeds, a fixed volume of liquid will be dispensed with each pouring operation.

However, in order to properly calculate the amount of alcohol served, compared to the amount of alcohol sales generated, an inventory must be performed, manually, and sometimes by eyesight estimation, of the approximate volume in the bottle.

Different bottles have different shapes and sizes. This drawback, along with the typically large number of bottles, presents a tedious and often inaccurate inventory that ultimately provides inexact figures for alcohol sales.

### BRIEF OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

Embodiments of the present disclosure may solve many of the problems in conventional beverage consumption and inventory tracking by providing an adjustable, controlled volume liquid pouring device (herein referred to as the “device”). A device consistent with embodiments of the present disclosure may be provided to track how much liquid is dispensed through the device. Although the various embodiments herein are disclosed with the context of “liquids,” one of ordinary skill in the field of the present disclosure may adapt the embodiments for any fluid type.

The device may comprise, but not be limited to, a measured pour spout which may be configured to a top portion of a bottle. For example, in some embodiments, a portion of the device may be inserted into the bottle opening. In this way, the device is configured such that the liquid passes through the device as the liquid is poured out of the bottle.

The liquid passing through the device may be tracked by a sensor configured within the device. In the various embodiments disclosed herein, the sensor may comprise, for example, a sensor stick consisting of a circuitry and at least one magnetic field sensor. The sensor may be operable with a magnetic ball bearing affecting the reading by the at least one magnetic field sensor. Alternatively, in some embodiments, the sensor may comprise at least one induction sensor configured to detect a metallic ball bearing. As the bottle, and, in turn, the device is titled, the ball bearing may displace within the device. The flux in magnetic field, as a result from the displacement, may be read by the sensor. Such interaction between the ball bearing and the sensor, may, in turn, serve as an indication as to the passing liquid from the bottle, through the device.

Still consistent with embodiments of the present disclosure, the device may be configured to collect data from the sensor readings. The data may be received by computing device operatively associated with the device. In some embodiments, a local computing device (e.g., embedded microprocessor) may be integrated within the device circuitry. Still, in other embodiments, a remote computing device (e.g., a hub) may be in remote communication with the device, via, for example, a communications module embedded within the device (e.g., Bluetooth protocol compatible).

Still consistent with embodiments of the present disclosure, the device may comprise a calibrated chamber which may be configured to limit the flow of liquid to a specific amount each time the bottle is positioned to dispense the liquid through the device. In some embodiments, the chamber may be adjusted to a desired volumetric flow rate of liquid. The adjustment of the chamber may be performed mechanically, through various components configured to affect the flow rate of liquid through the device. In some embodiments, a plurality of devices may come with a specific chamber caliber pre-set, with an inter-changeable cap for each pour amount. In turn, the specification of chamber calibration may be accounted for by a computing device associated with the device. In this way, based on the particular calibration of the device chamber, the sensor data may be analyzed to ascertain an amount of liquid poured through the device.

In yet further embodiments, a remote computing device (referred to herein as a “hub”) may receive data from a plurality of devices. The hub, may, in turn, aggregate, store, communicate, analyze, or otherwise operate on the devices and its corresponding received data. In some embodiments, the hub may reside in local proximity to the devices, so as to communicate with the devices in a near-field communication protocol. While in additional embodiments, the hub may be further embodied as, for example, an allocated resource in a cloud computing environment.

Still, in some embodiments, a local computing device in the field of communication (either near field or far field) with a plurality of devices may receive device data and communicate the data to the hub. The local computing device may then receive data back from the hub. In this way, a centralized operator may control and/or monitor a plurality of devices located in a plurality of locations. Accordingly, the hub may, by way of non-limiting example, calculate an amount of liquid left in each bottle (knowing the specification of each container) by summing the total amount poured by each device, and return corresponding data or instructions back to a local computing device in operative communication with the plurality of devices.

Further still, in some embodiments, a user interface may be provided for consuming and/or acting upon the data. The interface may be provided through, for example, but not limited, a web application or a mobile device application. In some embodiments, the hub may be in further communication with third party infrastructure, such as, but not limited to, for example, cloud computing, inventory management, distribution systems, and marketing and sales platforms. In this way, conventional systems and methods for managing liquor inventory and sales may be improved upon with the methods, systems, and devices of the present disclosure.

In some embodiments, a method for authenticating physical products may utilize dual-frequency radio frequency identification tags. A processing system may receive tag data from consumer devices that scan at least one RFID tag attached to physical products. The at least one RFID tag may comprise one of the following: a dual-frequency RFID tag attached to a physical product, the dual-frequency RFID tag supporting both near field communication and ultra-high frequency protocols, and a first near field communication tag and a second ultra-high frequency tag.

The at least one RFID tag may support both near field communication and ultra-high frequency protocols. The processing system may extract unique tag identifiers and cryptographic signature data from the received tag data. The system may validate tag authenticity by comparing cryptographic signature data against stored cryptographic keys. The method may determine tamper status by analyzing tamper detection circuitry integrated within tags. The processing system may retrieve product metadata from secure databases and generate personalized product information responses based on retrieved metadata and consumer interaction history.

In some embodiments, a system for product authentication and supply chain management may include a processing system configured to communicate with dual-frequency RFID tags. The system may include secure databases storing cryptographic keys and product metadata associated with unique tag identifiers. Handheld scanning devices may be configured to operate in multiple modes including quality control, inventory management, and packing operations. The processing system may receive tag data from consumer devices and handheld scanning devices, validate tag authenticity using cryptographic signature verification, determine tamper status through integrated tamper detection circuitry analysis, and generate personalized responses based on user context and product metadata.

In some embodiments, In some embodiments, a non-transitory computer-readable medium may store instructions that cause a processing system to perform authentication operations. The operations may include receiving tag data from dual-frequency RFID tags attached to physical products supporting both near field communication and ultra-high frequency protocols. The system may validate tag authenticity through cryptographic signature verification using stored secret keys. The operations may include determining tamper status through analysis of integrated tamper detection circuitry, managing product ownership records in immutable cryptographic ledgers, processing handheld device scanning data for quality control and inventory management operations, generating personalized consumer responses based on product metadata and interaction history, and maintaining supply chain visibility through geographic tracking and distribution pattern analysis.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates one embodiment of a cycle for which the invention goes through when in use.

FIG. 2 illustrates the invention, displaying various perspectives and views that include, but are not limited to, cross sections, individual parts independently viewed and various angles of the embodiment.

FIG. 3A illustrates one example embodiment of sensing device useable with the device of FIG. 1.

FIG. 3B is a side view of the sensing device of FIG. 3A.

FIG. 4A illustrates an embodiment of a device consistent with embodiments of the present disclosure, with a cover.

FIG. 4B illustrates an embodiment of a device consistent with embodiments of the present disclosure, without a cover on.

FIG. 5 illustrates an operating environment for providing a computing platform consistent with embodiments of the present disclosure.

FIG. 6 Illustrates another operating environment for providing a marketplace consistent with embodiments of the present disclosure.

FIG. 7 is a flowchart of a method of automated inventory control of dispensed liquids consistent with embodiments of the present disclosure.

FIG. 8 is a flowchart of a method of automated inventory control of dispensed liquids consistent with embodiments of the present disclosure.

FIG. 9 illustrates a computing device consistent with embodiments of the present disclosure.

FIG. 10 illustrates an operating environment for providing a computing platform consistent with embodiments of the present disclosure for authenticating physical products using dual-frequency radio frequency identification (RFID) tags.

FIG. 11 is a flowchart of a method for authenticating physical products using dual-frequency radio frequency identification (RFID) tags.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and”denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Conventional product authentication systems may suffer from several technical limitations that reduce their effectiveness in modern supply chains and consumer markets. Traditional authentication approaches may rely on static identifiers such as QR codes or basic RFID tags that can be easily cloned or reproduced. These systems may require consumers to download brand-specific applications for each manufacturer, creating friction that reduces adoption rates. Many existing solutions may provide only binary authentication results without offering additional value to encourage consumer engagement.

In the luxury spirits industry, manufacturers may face particular challenges with product authentication and consumer engagement. Counterfeit products may represent significant revenue losses and brand damage. Traditional tamper-evident seals may become non-functional after opening, providing no ongoing digital connection between the product and the consumer. Existing systems may not capture detailed analytics about consumer interactions with individual products, limiting manufacturers'ability to build direct relationships with end consumers.

Supply chain management systems may operate independently from consumer-facing authentication platforms, creating data silos that prevent comprehensive product lifecycle tracking. Manufacturing processes may require predetermined production quantities for tag association, reducing flexibility when actual production yields vary from initial estimates. Conventional systems may not support post-manufacturing authentication by third parties such as auction houses or resellers, limiting their utility in secondary markets.

Current digital marketing approaches for physical products may rely heavily on static packaging elements that cannot be updated after manufacturing. Brands may struggle to maintain ongoing digital relationships with consumers who purchase products through third-party retailers. Traditional loyalty programs may require separate enrollment processes that are disconnected from the physical product experience.

Geographic tracking and supply chain visibility may be limited in existing systems, making it difficult for manufacturers to detect unauthorized distribution or gray market activities. Quality control processes may require manual data entry after scanning operations, increasing the potential for errors and reducing operational efficiency.

Existing tamper detection technologies may cease functioning after the initial tamper event, providing no ongoing monitoring capabilities. Many authentication systems may not integrate cryptographic security measures, making them vulnerable to sophisticated cloning attacks. Consumer privacy concerns may not be adequately addressed in current implementations, particularly regarding location tracking and data collection across different jurisdictions.

Systems and methods are disclosed for product authentication and consumer engagement using dual-frequency radio frequency identification tags that address these technical limitations. The disclosed approach may utilize dual-frequency RFID tags supporting both near field communication and ultra-high frequency protocols to enable comprehensive product lifecycle management from manufacturing through consumer interaction.

The solution may employ cryptographic signature verification using stored secret keys to prevent cloning attacks while maintaining tamper detection capabilities throughout the product lifecycle. Dual-frequency tags may enable both consumer interaction through standard NFC-enabled mobile devices and supply chain management through specialized handheld scanning devices operating in multiple operational modes.

Manufacturing integration may be achieved through flexible tag association systems that eliminate the need for predetermined production quantities. Unassociated tags may be applied during production and registered post-application, allowing manufacturers to adjust production volumes without advance inventory planning. Quality control operations may be automated through bulk scanning capabilities that verify tag functionality and tamper status across product batches.

In practice, this allows label manufacturers to create reels of tags in advance of knowing exactly which products they will be applied to, making management of tag inventories significantly easier due to flexibility in application at production time.

The manufacturing integration system may implement flexible tag association workflows that eliminate the requirement for predetermined production quantities by maintaining pools of unassociated dual-frequency RFID tag devices 902 that can be dynamically allocated during production operations. The unassociated tag pool may comprise pre-manufactured tags containing unique identifiers and cryptographic keys but lacking specific product associations, enabling manufacturers to apply tags to products and establish associations post-application based on actual production yields and quality control results.

The manufacturer RFID reader 904 may interface with manufacturing execution systems (MES) through standard industrial communication protocols including Ethernet/IP, Modbus TCP, OPC-UA, or proprietary APIs to receive real-time production data including batch information, product specifications, quality control parameters, and production line status. The integration may enable automatic tag association as products move through production lines, with the manufacturer RFID reader 904 capturing manufacturing metadata and associating it with applied tags without requiring manual data entry or predetermined tag-to-product mappings.

The flexible association system may support various manufacturing scenarios including continuous production lines where tags are applied and associated in real-time, batch production processes where groups of products are processed simultaneously, and custom production workflows where individual products receive unique configurations and associations. The system may automatically adjust tag allocation based on production line speed, quality control results, and inventory availability to optimize manufacturing efficiency.

The manufacturer RFID reader 904 may implement high-speed tag programming capabilities that write initial product data, manufacturing metadata, and association information to dual-frequency RFID tag devices 902 during production operations. The programming process may utilize specialized “printer” functionality that operates at production line speeds, enabling simultaneous tag programming and label application without disrupting manufacturing workflows or requiring separate programming stations.

The tag programming process may write multiple data elements including unique product identifiers, manufacturing batch numbers, production timestamps, quality control results, ingredient specifications for consumable products, and initial ownership records establishing manufacturer ownership. The programming operation may verify successful data writing through read-back verification, error detection algorithms, and redundant programming attempts to ensure data integrity and tag functionality.

In conventional product authentication systems, the programming and product association of RFID tags may typically occur during tag manufacturing, rather than during product manufacturing, which may create a more streamlined approach during tag application but can be very inefficient from a tag production standpoint due to unknown yields of products to be manufactured. In the proposed embodiment the tag programming as product association steps are split, allowing more flexible application of tags to multiple different products. During the tag manufacturing process, each tag may be programmed with a unique identifier and cryptographic keys that may remain constant throughout the tag's lifecycle. Subsequently, during product manufacturing and tag application, the system may simply read the tag's pre-programmed identifier and create the necessary data associations in cloud-based systems, without requiring complex on-site programming operations. This approach may allow manufacturers to maintain pools of pre-programmed tags that can be flexibly applied to products as needed, with the actual product-specific associations happening through database entries rather than physical reprogramming of the tags. The cloud-side association model may enable greater manufacturing flexibility, as production quantities may not need to be predetermined before tag allocation, and may allow for dynamic adjustment of product-tag relationships based on actual production yields and quality control results.

For beverage production applications, the tag association process may include product-specific data such as alcohol content, aging information, barrel numbers for aged spirits, vintage dates for wine products, and regulatory compliance information required for distribution and sale. The association system may interface with laboratory information management systems (LIMS) to incorporate analytical results, quality control data, and certification information directly into tag memory during production.

The manufacturing integration system may implement automated quality control workflows where handheld scanning devices or fixed-position manufacturer RFID readers 904 verify tag functionality, data integrity, and tamper detection circuitry operation across production batches. The quality control process may include bulk scanning operations that simultaneously verify multiple tags, detect programming failures, identify defective tags, and generate quality control reports linking tag performance to manufacturing batch information.

The quality control system may implement statistical sampling procedures where representative samples from each production batch undergo comprehensive testing including cryptographic signature verification, tamper detection functionality testing, dual-frequency communication verification, and environmental stress testing. Quality control results may be automatically recorded in the product database 908 and associated with specific tags and production batches for traceability and compliance documentation.

Batch processing capabilities may enable manufacturers to process entire production runs simultaneously, with the system automatically associating all tags within a batch with common manufacturing parameters while maintaining individual tag identity and product-specific information. The batch processing system may support various batch sizes from small craft production runs to large-scale industrial manufacturing operations, with scalable processing capabilities that adapt to production volume requirements.

The manufacturer RFID reader 904 may integrate with automated production equipment including conveyor systems, packaging machinery, labeling equipment, and robotic handling systems to enable seamless tag application and programming without manual intervention. The integration may utilize industrial sensors, programmable logic controllers (PLCs), and machine vision systems to coordinate tag application timing, verify proper tag placement, and ensure accurate association with specific products.

The production line integration may implement real-time feedback mechanisms where tag programming results, quality control status, and association success rates are communicated back to production control systems to enable automatic adjustments of line speed, tag application parameters, and quality control thresholds. The feedback system may detect and respond to tag programming failures, communication errors, or quality control issues by automatically rejecting defective products, adjusting programming parameters, or alerting operators to system issues.

For high-speed production environments, the manufacturing integration system may implement predictive tag allocation where the system anticipates tag requirements based on production schedules, historical yield data, and current inventory levels. The predictive allocation may automatically prepare tag programming parameters, pre-stage unassociated tags for specific production runs, and optimize tag inventory management to prevent production delays due to tag shortages.

Consumer engagement may be enhanced through personalized product information responses generated based on product metadata and interaction history. The system may support product claiming mechanisms that establish ownership records in immutable cryptographic ledgers, enabling ongoing digital relationships between brands and consumers. User-generated content may be managed with configurable privacy settings and sharing permissions to build community engagement around products.

Supply chain visibility may be maintained through geographic tracking capabilities that analyze distribution patterns and detect unauthorized channels. Handheld scanning devices may operate in configurable modes including quality control verification, inventory management, and shipping container association to provide real-time supply chain updates. Container-level tracking may enable automated status updates throughout distribution networks.

The handheld scanning devices may comprise ruggedized mobile computing platforms such as (but not limited to) Chainway C72, or similar industrial-grade devices equipped with dual-frequency RFID readers supporting both NFC (13.56 MHz) and UHF (860-960 MHz) communication protocols. The handheld devices may include high-gain antennas optimized for reading dual-frequency RFID tag devices 902 at extended ranges up to several meters for UHF operations and close-proximity ranges for NFC operations, with automatic protocol detection and switching capabilities.

The handheld scanning devices may operate in multiple configurable modes including quality control mode for manufacturing verification, inventory management mode for location tracking and stock counting, packing mode for container association and shipping preparation, and receiving mode for distribution center operations. Each operational mode may implement specific scanning protocols, data collection requirements, and user interface configurations optimized for the particular workflow and operational environment. The handheld scanning devices may operate in inventory management mode for tracking product locations and performing stock operations throughout the supply chain. In this operational mode, the handheld devices may enable users to increment or decrement stock counts when products are added to or removed from inventory locations, with automatic synchronization to the product database 908 to maintain accurate real-time inventory records. The inventory management mode may support the addition of new stock types through configurable product templates that capture essential metadata for different product categories, enabling flexible inventory expansion without requiring system reconfiguration. Location tracking capabilities within this mode may utilize fixed reference points, GPS coordinates, or zone-based tracking to automatically associate scanned products with specific storage locations, distribution centers, or retail environments. The inventory management functions may include batch operations for processing multiple items simultaneously, threshold alerts for automatic reordering when stock levels fall below configured minimums, and historical tracking of inventory movements to support audit requirements and loss prevention initiatives. The handheld scanning devices may operate in packing mode to create hierarchical associations between individual product tags and shipping container tags. In this operational mode, the handheld devices may not only establish container-level tracking records linking multiple products for distribution, but may also associate specific product types contained within each container. The packing mode may enable users to identify both the container itself and the specific contents contained within it, such as identifying that a particular shipping container holds exclusively a selected product type or a predetermined mix of different products. This container-content association may be stored in the product database 908 to facilitate accurate inventory tracking, streamline receiving operations, and enable precise fulfillment verification without requiring physical inspection of container contents. The detailed content association may support advanced supply chain analytics including product-specific distribution patterns, container utilization efficiency, and automated inventory forecasting based on container contents rather than just container counts.

In Quality Control Mode, the handheld devices may perform comprehensive tag verification including cryptographic signature validation, tamper detection status verification, dual-frequency communication testing, and data integrity checks. The quality control scanning may support bulk operations where multiple tags are scanned simultaneously, with automatic comparison against manufacturing specifications and quality control thresholds to identify defective tags or products requiring additional inspection.

The Inventory Management Mode may enable rapid scanning of large quantities of tagged products for location updates, stock counting, and inventory reconciliation operations. The handheld devices may automatically capture location context through GPS positioning, barcode scanning of location identifiers, or manual location entry, then associate scanned tags with specific warehouse locations, storage zones, or distribution centers for real-time inventory tracking.

The supply chain management system may implement comprehensive geographic tracking capabilities that capture and analyze location data associated with tag scanning events throughout the distribution network. The geographic tracking may utilize GPS coordinates from handheld scanning devices, cellular tower triangulation, WiFi access point identification, or manual location entry to establish approximate product locations during supply chain operations.

The system may maintain detailed distribution maps showing authorized retailer locations, approved distribution centers, and legitimate supply chain partners to enable comparison against actual scanning locations for unauthorized distribution detection. The geographic analysis may identify products appearing in unauthorized locations, detect gray market activities, and generate alerts when products are scanned outside approved distribution channels or geographic regions.

The distribution pattern analysis may implement statistical algorithms that identify normal distribution patterns for specific product categories, detect anomalous geographic clustering that may indicate counterfeiting operations, and track product movement velocities to identify suspicious rapid movement patterns inconsistent with legitimate distribution timelines. The analysis system may generate supply chain visibility reports showing product flow patterns, distribution efficiency metrics, and potential security concerns for manufacturer review.

For international distribution, the geographic tracking system may account for customs processing, international shipping delays, and regulatory requirements that affect normal distribution patterns. The system may maintain separate geographic models for different markets and regulatory environments to ensure accurate anomaly detection across diverse international supply chains.

The supply chain management system may implement hierarchical tracking capabilities where individual product tags are associated with shipping container tags, pallet tags, or case tags to enable efficient bulk tracking throughout distribution operations. The hierarchical association may be established during packing operations where handheld devices scan individual products and associate them with container identifiers, creating parent-child relationships that enable container-level tracking without requiring individual product scanning at each distribution checkpoint. The items may or may not already be associated, so the handheld device can scan individual products or individual unassociated tags, then perform an association to a product, then associate those tags with a container. This flexible association capability may enable field operations where products and tags may be processed in any sequence, without requiring predetermined association workflows. The handheld device may first identify an unassociated tag through its unique identifier, then scan a product barcode or other identifier to create the product-tag association in the product database 908, and subsequently associate that newly-linked product-tag pair with a container tag. This multi-stage association process may support scenarios where products arrive at distribution centers without pre-applied tags, where replacement tags need to be applied to products with damaged original tags, or where products need to be repackaged into different container configurations during distribution operations.

The container association process may support various packaging hierarchies including individual products within cases, cases within pallets, pallets within shipping containers, and containers within transportation vehicles. Each level of the hierarchy may maintain its own dual-frequency RFID tag with appropriate read range and data storage capabilities for the specific tracking requirements and operational environment.

The hierarchical tracking system may enable automatic status propagation where scanning a container tag automatically updates the status of all associated individual products, reducing scanning time and operational overhead while maintaining detailed tracking granularity. The system may support partial container operations where individual products are removed from containers, with automatic updating of hierarchical associations and inventory records.

For complex distribution scenarios, the container tracking may support multiple association levels simultaneously, enabling products to be associated with immediate packaging, shipping containers, and transportation vehicles concurrently. The multi-level association may provide redundant tracking capabilities and enable detailed analysis of distribution efficiency and product handling throughout the supply chain.

The supply chain management system may implement real-time data synchronization between handheld scanning devices and central database systems to ensure immediate visibility of inventory changes, location updates, and status modifications across the entire supply chain network. The synchronization system may utilize cellular data networks, WiFi connectivity, or satellite communication to maintain continuous connectivity with central systems even in remote distribution locations.

The real-time synchronization may implement conflict resolution algorithms that handle simultaneous updates from multiple handheld devices, ensure data consistency across distributed operations, and maintain transaction integrity during network connectivity interruptions. The synchronization system may include local data buffering capabilities that store scanning results locally when connectivity is unavailable, with automatic synchronization when network connectivity is restored.

The inventory management system may support various scanning workflows including cycle counting, full inventory audits, exception-based scanning for discrepancy resolution, and targeted scanning for specific product searches or quality investigations. Each workflow may implement appropriate scanning protocols, data validation requirements, and reporting formats optimized for the specific operational requirements and user roles.

The data management system may maintain comprehensive audit trails of all scanning activities, location changes, and status updates to support regulatory compliance, quality investigations, and operational analysis. The audit trails may include operator identification, timestamp information, location data, and scanning device identification to provide complete traceability of supply chain operations.

The disclosed system may integrate manufacturing operations, supply chain management, and consumer engagement into a unified platform that maintains data consistency across multiple touchpoints while preserving user privacy and enabling comprehensive product lifecycle analytics.

The present disclosure includes many aspects and features. Moreover, while many aspects and features relate to, and are described in, the context of beverage dispensing from a bottle, embodiments of the present disclosure are not limited to use only in this context. For example, any fluid or liquid dispensing applications may be anticipated to be within the scope of the present disclosure.

### I. Overview

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Methods, systems, and devices disclosed herein may be collectively referred to as a “platform.” A platform consistent with embodiments herein may be used by individuals or companies to track an amount of liquid poured from at least one liquid container. The platform may comprise a tracking device and a computing hub in operative bi-directional communication.

The device may be configured to a liquid dispensing container such as, but not limited to, a bottle. The device may be configured to receive a liquid from the container and transfer the liquid through a chamber within the device. As the liquid is transferred through the device, a computing element and sensing component integrated within the device may be configured to track an amount of liquid dispensed through the device. A communications module may then communicate the data with the hub.

Still consistent with embodiments of the present disclosure, the device may be configured to limit an amount of liquid dispensed through the device by way of a calibrated chamber which dispenses a specific amount each time the bottle inverts. In turn, the device may be configured to sense an amount of liquid poured through the device. The device may then communicate the sensor data to a computing element, either integrated within the device itself, and/or to a network computing element.

The computing element, having received the data from the device, may then calculate, for example, at least one of the following: an amount of liquid dispensed and an amount of liquid remaining in the bottle to which the device is attached. Accordingly, the device may be paired or registered with the platform, along with a specification of a liquid container type that the device is configured to. In this way, the platform may be configured to report a plurality of metrics associated with a plurality of liquid containers having a device consistent with embodiments of the present disclosure configured thereto.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Device Design and Operation

A device consistent with embodiments of the present disclosure may be, for example, a liquid pouring spout (referred to as a “device” throughout the present disclosure) that connects to a liquid container. In some embodiments, as with conventional liquid pouring spouts, the device may comprise an adjustably controllable measuring liquid pourer for dispensing liquid in a predetermined quantity.

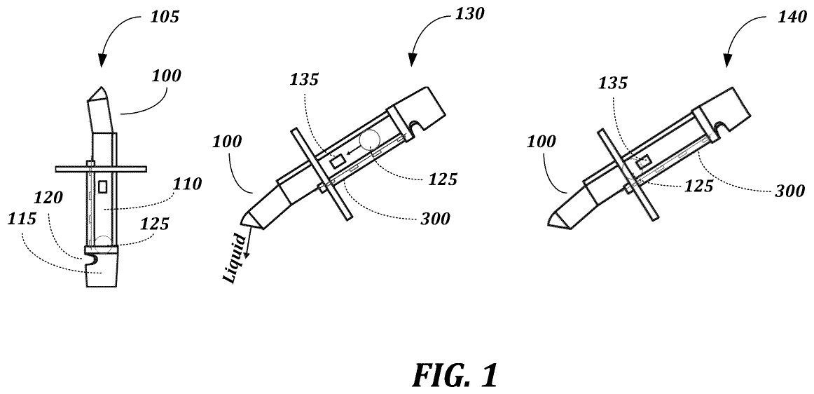

FIG. 1 illustrates one possible embodiment of the liquid pouring spout 100, in three configurations. In a first configuration 105, spout 100 may be in an upright position, ready to receive liquid. In a second configuration 130, spout 100 may be receiving liquid through the chamber. In a third configuration 140, spout 100 may have completed the dispensing of liquid. The following disclosure will describe spout 100, as a device 100, through the various configurations.

Consistent with embodiments of the present disclosure, device 100 may comprise a calibrated chamber 110 which may be configured to limit the flow of liquid to a specific amount each time the bottle is positioned to dispense the liquid through the device. In some embodiments, chamber 110 may be adjusted to a desired volumetric flow rate of liquid. The adjustment of chamber 110 may be performed mechanically, through various components configured to affect the flow rate of liquid through the device. In some embodiments, a plurality of devices may come with a specific chamber caliber pre-set, with an inter-changeable cap 115 for each pour amount.

Still, in further embodiments, it is anticipated that, for example, a computer-controlled actuator may be configured to dynamically and programmatically adjust a property of device 100 (e.g., an opening 120 of cap 115) so as to affect the flow rate through device 100. In this way, for example, a remote operator of the device may be enabled, via a computing device and communications module, to control the limits of liquid flow through device 100. In turn, the specification of chamber calibration may be accounted for by a computing device associated with device 100. In this way, based on the particular calibration of the device 100 (e.g., by way of chamber 110 or cap 115), the sensor data may be analyzed to ascertain an amount of liquid poured through the device.

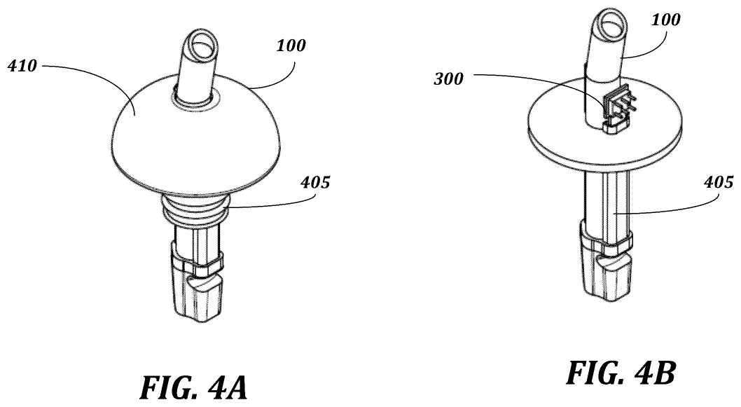

Referring still to FIG. 1, chamber 110 within upright configuration 105 may comprise a ball bearing 125 resting at the base of chamber 110, adjacent to cap 115. Cap 115 may comprise a cut-out 120 for receiving a liquid into chamber 110 from a liquid container to which device 100 may be configured. In some embodiments, cap 115 may be configured so as to be inserted into a liquid container opening (e.g., at the top of a bottle) and receive the liquid from the container. In such embodiments, and as illustrated with reference to FIGS. 4A and 4B, a stopping and sealing means 405 may be provided to ensure a secure connection to a liquid container. The stopping and sealing means 405 may comprise, but not be limited to, for example, a silicon, rubber, elastomeric, silicone, polyurethane, plastic, or cork material. Still, within upright configuration 105, ball bearing 125 may rest at the base of the chamber, thereby sealing the liquid within the container connected to device 100.

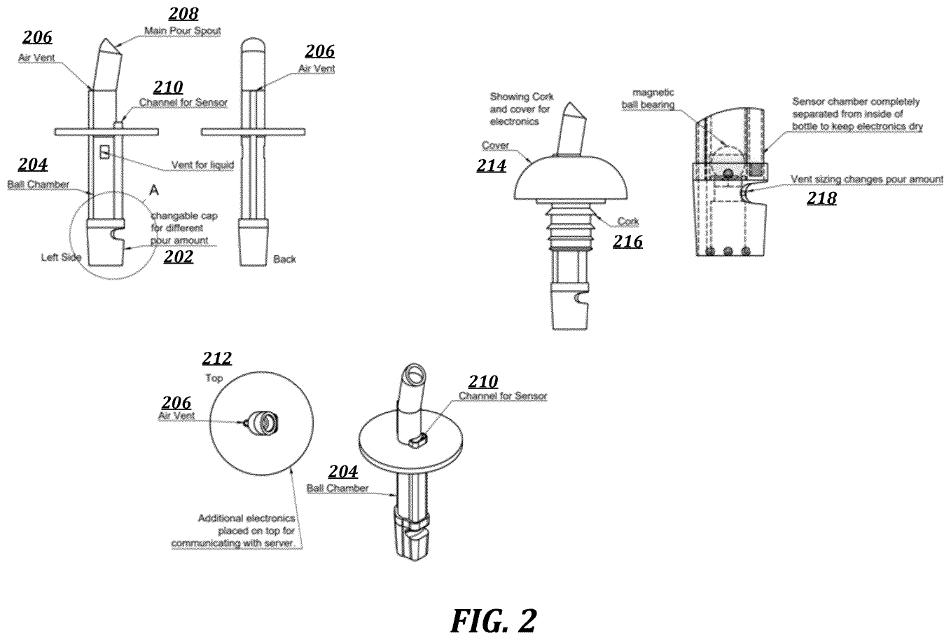

Referring back to FIG. 1, pouring configuration 130, liquid may enter device 100 through opening 135, filling chamber 110. A vacuum effect may be created with opening 120, thereby causing ball bearing 125 to float on the liquid through chamber 110, as facilitated by an air vent cut-out 120 positioned within chamber 110. To understand the operation of device 100 during pouring configuration 130, we turn to FIGS. 2-4.

Still consistent with embodiments of the present disclosure, and as illustrated in FIG. 2, a hollow space (herein known as a “channel for sensor”) may be designed alongside chamber 110, spanning the length of chamber 110. The channels purpose may be, but is not limited to, to create a space for the sensor stick to be placed secure and flush alongside the ball chamber 110.

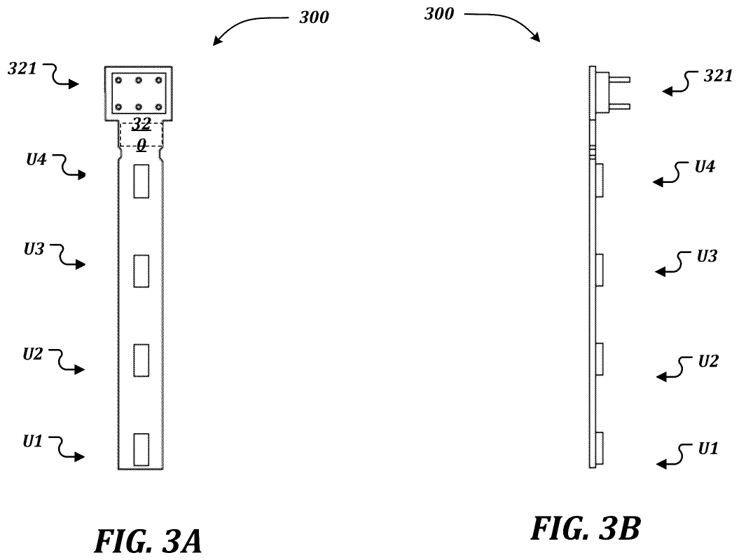

A magnetic sensing device comprising a magnetic sensor circuitry (hereinafter referred to as a “sensor stick”) may be placed inside the channel for sensor. FIG. 3 illustrates one example embodiment of sensing device 300, and FIG. 4 illustrates how sensing device 300 may be inserted into the channel. Sensing device 300 may comprise two primary components: a circuit board of a predetermined width having at least one processor 320 thereon, the length of the circuit board being at least the span of the ball chamber 110; and a plurality of sensors U1, U2, U3, and U4. In some embodiments, the sensors may comprise magnetic field sensors configured to detect a magnetic ball bearing. In alternative embodiments, the sensors may comprise induction sensors configured to detect a metallic ball bearing through electromagnetic induction. The sensing device 300 may also include a physical connector or interface 321, configured to communicate with an external processor (not illustrated) or other device. It is noted that processor 320 may be physically present on the sensing device 300, or may be a separate device (not illustrated). The circuit board may be a printed circuit board and may include printed circuitry and may be sized to be retained within the channel for sensor. There may be no limitation to a quantity of sensors used. In some embodiments, the quantity may range from one to four sensors, mounted on the circuit board and orientated, by way of non-limiting example, equidistant from each other (See FIG. 3, sensors U1-U4).

Consistent with embodiments of the present disclosure, ball bearing 125 may have magnetic properties so as to interface with sensing device 300. The magnetic field sensors on the sensing device 300 may be used to determine the magnetic ball bearing's location. In some embodiments, sensing device 300 may determine the magnetic ball bearing's location using, for example, without limitation, the hall effect. The hall effect is the production of a voltage difference across an electrical conductor, transverse to an electric current in the conductor and to an applied magnetic field perpendicular to the current. Alternatively, in some embodiments, ball bearing 125 may comprise a metallic ball bearing, and sensing device 300 may comprise at least one induction sensor configured to detect the metallic ball bearing through electromagnetic induction. The induction sensor may generate an electromagnetic field and detect changes in the field caused by the presence or movement of the metallic ball bearing. By tracking location of ball bearing 125 as a function of the pour spout's position, the amount of liquid released may be tracked by a computing device in accordance to the embodiments disclosed herein. Tracking may comprise, but not be limited to, for example, calculating the displacement of ball bearing 125 within chamber 110.

In some embodiments, the sensors may be coupled with additional components, use alternative measurements (e.g., magnetic flux, electrical flux, or EM flux) to ascertain the ball bearing's location. For example, optomechanical systems and corresponding sensors may be used in conjunction with, or ingratiated with, the sensing device 300. In further embodiments, a magnetically operated mechanical switch may be used in conjunction with, or ingratiated with, the sensing device 300. In yet further embodiments, MEMS magnetic field sensors using Lorentz force may be used in conjunction with, or ingratiated with, the sensing device 300. Furthermore, although particularly described as using a magnetic field sensor or other sensor in the several preceding examples herein, capacitance sensing, limit-switch sensing, physical displacement sensing, and any other suitable form of sensing is also applicable. Accordingly, it should be understood by one of ordinary skill in the field of the present disclosure that a plurality of systems may be adapted to be in conjunction with, or integrated with, sensing device 300 to achieve the desired results.

Referring now to FIG. 4A and FIG. 4B, device 100 may comprise a cover 410 corresponding to the area and shape of the main pour spout and air vent 135, so as to fit flush with the main pour spout and prevent moisture from entering through cover 410. The material of cover 410 may be made from, but not limited to metal, plastic, or wood. Cover 410 may be used, but not limited to, for example, insulate the channel for sensor from outside elements such as, but not limited to, liquid, dirt, and grime.

Accordingly, referring back to FIG. 1, device 100 may allow measured liquid pours specified by a user to be administered from a bottle in discrete portions. Device 100 may be attached to the opening of a bottle containing liquid. The starting orientation, in the initial configuration 105, may be such that a base of a liquid container (e.g., the bottle) is level with the ground, with the pour spout facing upwards, perpendicular with the ground, and ball bearing 125 is at the bottom of chamber 110.

Turning towards configuration 130, device 100 may then invert (i.e., Rotated 90°-180° from original orientation) such that ball bearing 125 begins travel down the path of the ball chamber 110. The liquid in ball chamber 110 may then be expelled by the force of gravity, and force ball bearing 125 down the chamber 110. The displacement of ball bearing 125 is detected by sensing device 300 and is used, in turn, to track an amount of liquid dispensed during the pour.

Now in configuration 140, ball bearing 125 may cease travel when it reaches “top” of the ball chamber 110, as ball bearing 125 may be configured to seal a pouring hole in device 100. In some embodiments, ball bearing 125 may also cover, at least in part, air-vent 135, further affecting the liquid flow rate. In scenarios of a partial pour, ball bearing 125 may not be completely forced to the “top” of chamber 110 (e.g., device 100 is not inverted long enough for ball bearing 125 to travel the length of chamber 110 is then reverted to its initial configuration 110. Nevertheless, sensing device 300 may still measure the total displacement of ball bearing 125 within chamber 110.

In some embodiments, the measured distance may be exported to a computing device (e.g., a hub). Having each pour spout assigned to a particular spirit, the measured distance may serve as input to an algorithm configured to calculate an amount of liquid dispensed from the bottle to which device 100 is affixed.

As described above, the device 100 may include a variety of features and mechanics configured to assist in tracking inventory. For example, with reference to FIG. 2, the device may include a bottom cap 202. The bottom cap 202 includes a first opening 218 to receive a liquid from a bottle and a second opening to measurably release the received liquid into ball chamber 204. Generally, increasing the size of the first opening 218 of the bottom cap 202 decreases the predetermined amount of the liquid. Similarly, decreasing the size of the first opening 218 of the bottom cap 202 increases the predetermined amount of liquid.

The ball chamber 204 is arranged on the bottom cap 202. The ball chamber 204 includes a bottom opening in fluid communication with the second opening of the bottom cap 202. The ball chamber 204 includes a cylindrical cavity arranged to retain the ball bearing and the predetermined amount of liquid. The cylindrical cavity is also in fluid communication with the bottom opening. Finally, the ball chamber 204 also includes a top opening in fluid communication with the cylindrical cavity so that liquid can be poured through to main pour spout 208.

Air vent 206 is arranged proximate the ball chamber 204. Air vent 206 is configured to receive air from an exterior of a liquid dispensing container and direct the received air to the interior of the liquid dispensing container.

The sensor cavity 210 is arranged proximate the ball chamber 204. The sensor cavity 210 is also termed a “channel for sensor” herein, and is an elongated channel configured to retain at least one sensor. Generally, the at least one sensor can be actuated by the ball bearing as described herein. Additionally, the sensor cavity 210 is sealed to prevent the liquid from entering the sensor cavity 210 and fouling the at least one sensor.

The device 100 may also include a top 212 configured to seat onto or about a neck or top opening of a liquid dispensing container, such as a liquor or wine bottle. The top 212 may be covered by cover 214. Additional electronics, including any necessary antennas, transceivers, or other electronics may be housed beneath the cover 214. Additionally, the device 100 can include a sealing member or sealing ring 216 arranged about the ball chamber, configured to seal and/or seat within the bottle neck beneath the top 212.

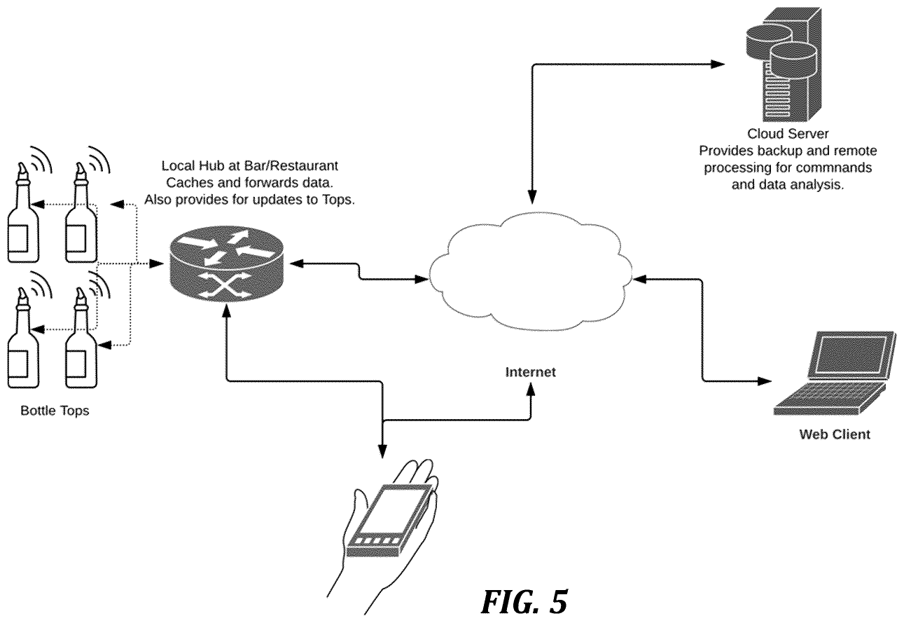

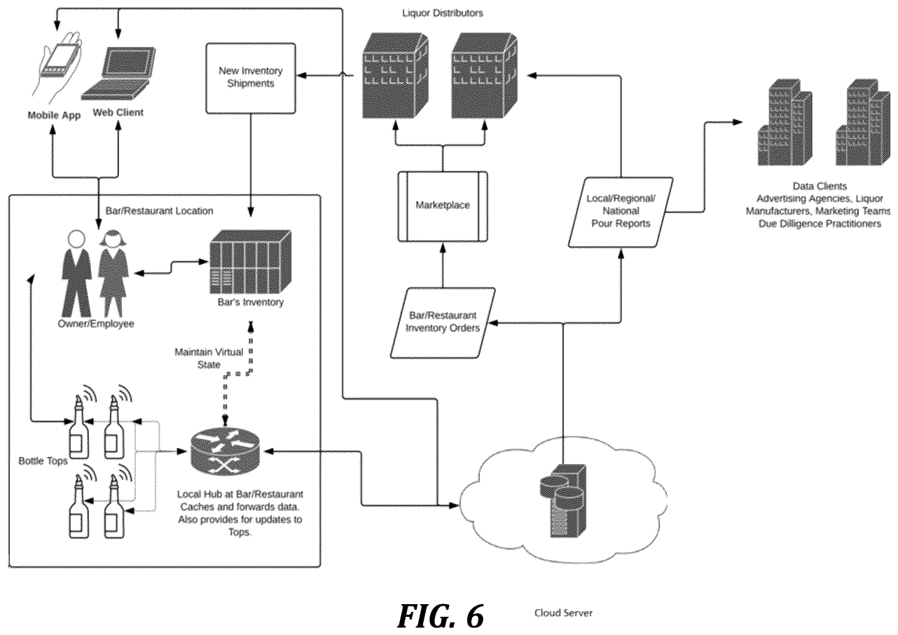

Hereinafter, operation of individual inventory tracking devices 100 is presented with reference to FIGS. 5 and 6.

### III. Platform Design and Operation

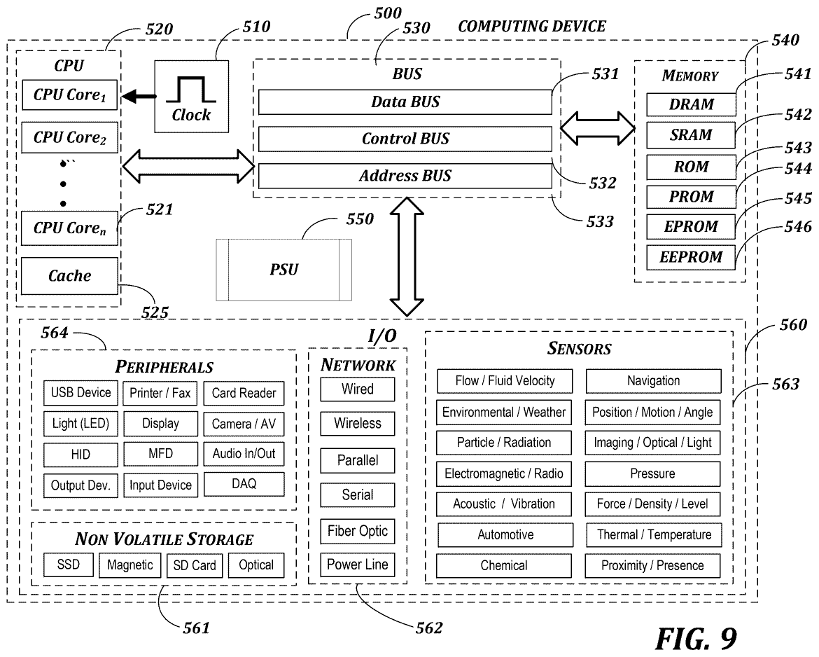

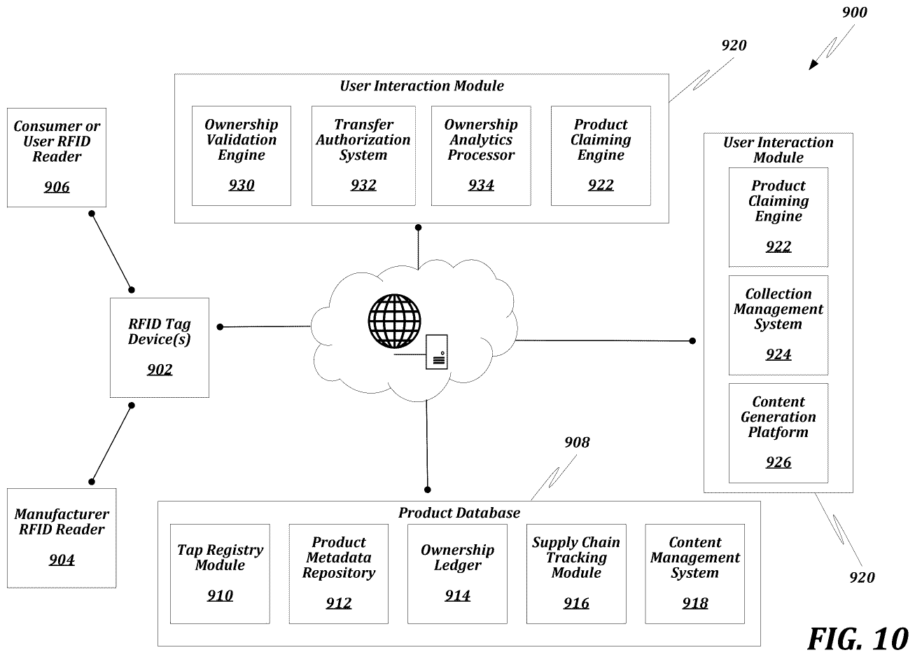

FIGS. 5 and 6 illustrate possible operating environments through which a platform consistent with embodiments of the present disclosure may be provided. By way of non-limiting example, the platform may be hosted on a centralized server, such as, for example, a hub or a cloud computing service. A user may access the platform through a software application. The software application may be embodied as, for example, but not be limited to, a website, a web application, a desktop application, and a mobile application compatible with a computing device FIG. 9. One possible embodiment of the software application may be provided by the BarMinder™ suite of products and services provided by BarMinder, Inc.

As will be detailed with reference to FIG. 9 below, the computing device through which the platform may be accessed may comprise, but not be limited to, for example, an integrated circuit, a desktop computer, a laptop, a tablet, mobile telecommunications device, or an Internet of Things (IOT) device.

A platform for tracking beverage consumption and inventory may be configured to operate as disclosed herein. Although the stages of operation depicted herein are disclosed in a particular order, it should be understood that the order is disclosed for illustrative purposes only. Stages may be combined, separated, reordered, and various intermediary stages may exist. Accordingly, it should be understood that the various stages may be, in various embodiments, performed in arrangements that differ from the ones illustrated. Moreover, various stages may be added or removed without altering or deterring from the fundamental scope of the depicted methods and systems disclosed herein.

Consistent with embodiments of the present disclosure, sensing device 300 may be operatively associated with a communications module (e.g., integrated near-field communications technology) to send data wirelessly to a hub. The communications module may be a part of, or separate from, the at least one processor 320. As mentioned above, a hub may be, for example, an on-premises computing device in local proximity to device 100. Each data stream may be associated with a particular device configured to a particular bottle, each programmatically registered with the platform. In this way, the platform may ascertain which device is attached to which bottle. The data streams communicated to the hub associated with a particular device may be assigned a “pour number” uniquely for the particular device. The data stream may comprise, for example, but not be limited to, a volume of any particular pour (½ oz, 1 oz, 1.5 oz etc.), and total volume poured since placed on new bottle, battery voltage, and other metrics on functionality of device (e.g., recently placed on new bottle, etc.).

Still consistent with embodiments of the present disclosure, the hub may send data back to device 100 (e.g., software updates). Such bi-directional communication may be facilitated by a communications module configured to communicate directly over a local network with, for example, a software application associated with the platform. In addition, the hub may be configured to communicate with other computing devices in a networked environment. One such computing device may be within a cloud computing environment, connected through a telecommunications channel. The cloud computing device may be configured to track a plurality of devices within a plurality of locations, and enable remote computing devices (e.g., a mobile phone) to connect thereto. In some embodiments, data collected on the cloud computing environment may be used and sold to companies such as, but not limited to, advertising agencies, liquor manufacturers, marketing teams, and due diligence practitioners.

The mobile app and web client may enable the user to interact with the data collected. The app may communicate through the internet to the cloud servers, and directly to the Hub. This facilitates easier setup and management if Internet connectivity isn't available. The mobile app may have the following data aggregated: relevant data generated by the system, inventory levels, predictions of when inventory orders need to be placed, automatic adding of needed inventory to a cart for simple ordering or the ability to enable automatic ordering at set thresholds, access to a marketplace to order new inventory, allows manual reconciliation with physical counts during auditing to bring system's count of inventory in line.

In yet further embodiments, and as illustrated in FIG. 6, a “marketplace” may provide a centralized network for communication between buyers of spirits, liquor distributors, and data clients. The marketplace may facilitate a streamlined sales process for distributors to advertise, solicit, and sell their spirits to prospective buyers. When an order of spirits is needed, they may be requested or publicly posted in the marketplace, and distributors may compete to bid and fill orders. Distributors traditionally employ large salesforces to sell through their products. The marketplace reduces the work required to place and fulfill orders and may increase distributors'margins. The marketplace may charge the distributor a set percentage fee on each order. Distributors may manage actual delivery of inventory to the physical location of the bar.

An exemplary process as shown in FIG. 6 may follow the following procedure. Although the stages of operation depicted herein are disclosed in a particular order, it should be understood that the order is disclosed for illustrative purposes only. Stages may be combined, separated, reordered, and various intermediary stages may exist. Accordingly, it should be understood that the various stages may be, in various embodiments, performed in arrangements that differ from the ones illustrated. Moreover, various stages may be added or removed without altering or deterring from the fundamental scope of the depicted methods and systems disclosed herein.

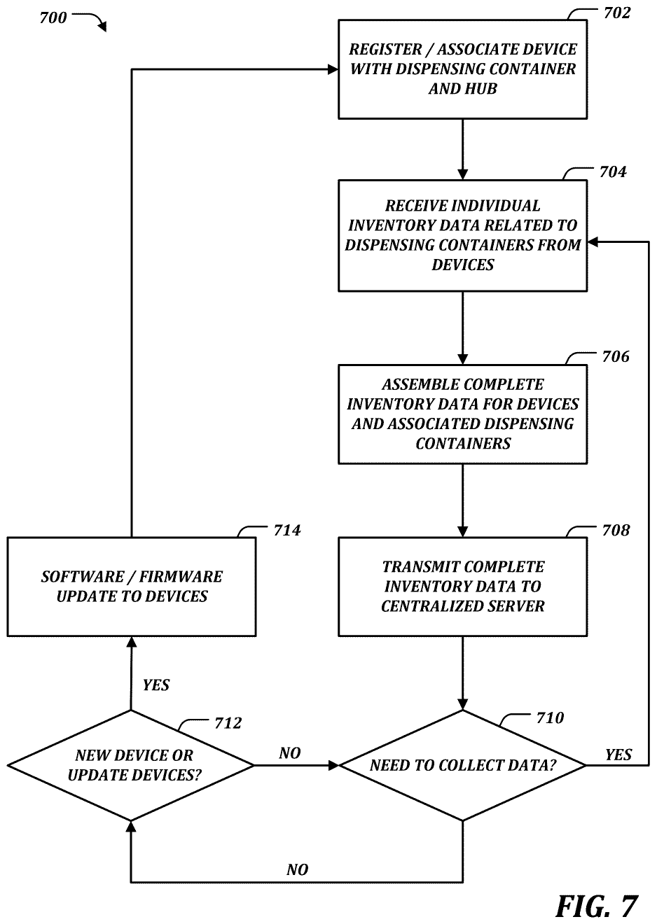

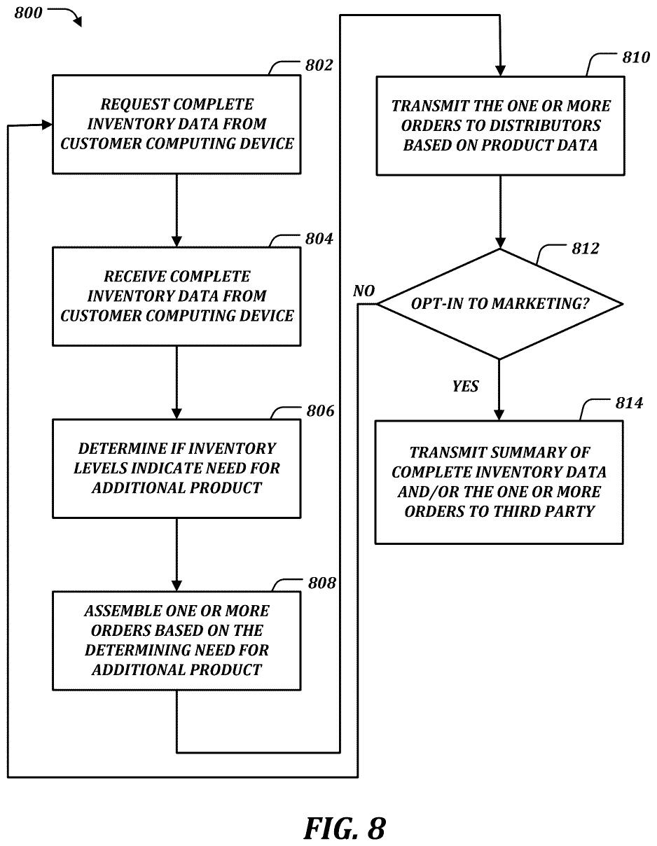

First, a plurality of devices consistent with embodiments disclosed herein may collect information from their respective bottles. Each device's data may be sent to, for example, the hub, which calculates and logs liquid container inventory. The logged inventory may be viewed from a computing device connected to the hub. Then, data from the hub is sent to, for example, a centralized server. Based on the information on the server, orders may be placed on the marketplace, or that information may be sold to third parties. As orders are placed and fulfilled in the marketplace, distributors may coordinate the shipping and distribution of the ordered products. Hereinafter, a more detailed discussion of operation of the platforms described herein is provided with reference to FIGS. 7-8.

FIG. 7 is a flowchart of a method 700 of automated inventory control of dispensed liquids, in accordance with various embodiments of the present disclosure. The method 700 may include registering and/or associating a device with a particular liquid dispensing container and a hub, at block 702. Generally, registering includes assigning associated identifying data to an inventory tracking device, where the identifying data identifies a particular type of liquid dispensing container associated with the inventory tracking device.

The method 700 may further include receiving individual inventory data related to dispensing containers from the registered devices, at block 704. For example, individual inventory tracking devices 100 can transmit volumetric data of the liquid dispensing container to the hub.

The method 700 may further include assembling inventory data for the devices and associated dispensing containers responsive to the receiving, at block 706. The assembling can include aggregating data for every bottle for a customer that has an active inventory tracking device 100.

The method 700 may further include transmitting the assembled inventory data to a centralized server or cloud server, at block 708. For example, the centralized cloud server is described with reference to FIGS. 5 and 6, above. In addition to the assembled inventory data, or in the alternative, the hub may transmit one or more purchase orders to the centralized server. For example, the one or more purchase orders may include inventory data or other suitable data to ensure an order is validly placed from the hub.

Thereafter, the method 700 may include determining a need to collect data from the registered devices, at block 710, and determining if a new device is present, if an unregistered device is within range, or if a software update is available, at block 712. Generally, the need to collect data may be based on a flow of business, a total number of pours from a device or other indicators of diminishing inventory. The need may also be based on a predetermined schedule, regular schedule, or other schedule. Software update availability may be manually pushed onto the hub or may be based on a predetermined schedule to check for updates.

If there is a need to collect data, the method 700 resumes at block 704. If there is a software update available, the method 700 includes pushing the software and/or firmware update to the registered device, at block 714. The method 700 may subsequently continue with block 702 or 704, depending upon any desired implementation of the methodology.

As described above, the method 700 includes operations configured to be performed by a hub or localized processor, and individual devices. Hereafter, method 800 is described as related to operations configured to be performed through a centralized server or cloud-based architecture.

FIG. 8 is a flowchart of the method 800 of automated inventory control of dispensed liquids. The method 800 includes requesting inventory data from a customer computing device, at block 802. The inventory data may be received from a hub over a network. The inventory data may be received regularly, on a regular schedule, or may be received according to a different schedule. The inventory data may also be received based on a demand. The demand may be a demand for additional product. The demand may be based on an amount of liquid poured/served, an amount of sales, activity at a customer location, or other attributes. This network may be separate or different from the network used by the hub to communicate with the individual device 100.

The method 800 further includes receiving the requested inventory data from the customer computing device, at block 804. The inventory data may be received over the network. The inventory data may include volumetric data, sales data, and/or other suitable data.

The method 800 also includes determining if inventory levels indicate a need for additional product, at block 806. For example, the need may be based on sales volume or other attributes, including predicted holidays or large sales events. Other attributes for need can be adjusted based on any desired implementation.

The method 800 also includes assembling one or more purchase orders based on the determining the need for additional product, at block 808. The method 800 also includes transmitting the one or more orders to distributors based on product data, at block 810. The distributors may be sent purchase orders based on inventory at the distributor or availability data for products. Thus, the method 800 may also include choosing a distributor based on an attribute, such as availability of a food product or spirit.

It is noted that both the hub and centralized server may be equipped to issue purchase orders. For example, according to one aspect, the hub may issue purchase orders on behalf of a customer. According to an additional aspect, the centralized server may issue purchase orders on behalf of a customer.

The method 800 also includes determining that a customer associated with the one or more orders has opted-in to receive marketing promotions or otherwise authorized release of purchase order or inventory data, at block 812. If the customer has opted-in or otherwise agreed, the method 800 can include transmitting a summary of the inventory data and/or the one or more purchase orders to a third party, at block 814.

As described above, various methodologies associated with automated inventory control of dispensed liquids has been provided herein. The methodologies may be associated with any dispensed liquid, such as food products, liquors, wines, or other consumable liquids. In other implementations, the methodologies may be associated with a dispensed liquid such as motor oil, washing fluid, or other liquids associated with automotive maintenance. In other implementations, the methodologies may be associated with a dispensed liquid such as a hair product, nail polish, cream or lotion, or other liquids associated with a beauty salon. In still further implementations, the methodologies may be associated with any liquid to be dispensed that is measurable in volume through sensing displacement, as described herein.

### IV. System for Product Authentication and Supply Chain Management

A comprehensive digital identity system for physical products using advanced smart tags is disclosed. Each product receives a special tag that acts like a digital fingerprint, containing secure information that cannot be copied or faked. When consumers tap the product with their smartphone, they instantly receive authentic product information and can interact with the brand in new ways.

The system works like a digital bridge connecting manufacturers, retailers, and consumers throughout a product's entire life. For manufacturers, the system provides flexible production capabilities where tags can be applied to products and registered after manufacturing, eliminating the need to predict exact production quantities in advance. Quality control becomes automated through devices that can scan multiple products simultaneously to verify authenticity and detect any tampering.

For consumers, the experience is seamless and valuable. Simply tapping a product with any smartphone provides immediate access to product information, authenticity verification, and the ability to “claim” ownership of premium items. Consumers can build digital collections of their products, share experiences with friends, and receive personalized content from brands. The system works without requiring separate apps for each brand, making it universally accessible.

Supply chain management becomes transparent and efficient through specialized handheld devices that track products from factory to consumer. These devices can operate in different modes-quality control during manufacturing, inventory tracking in warehouses, packing operations for shipping, and receiving verification at retail locations. All of this information flows into a secure system that provides complete visibility of where products are and how they move through distribution channels.

The security foundation relies on cryptographic technology that makes counterfeiting virtually impossible. Each tag contains secret digital keys that generate unique signatures when scanned. The system can detect if someone tries to copy or tamper with a tag, and it maintains a permanent record of all interactions that cannot be altered or deleted. This creates an unbreakable chain of authenticity from manufacturing through consumer ownership. Item claiming is immutable, so it may be true that that piece provides an unbreakable authenticity chain through ownership records. However, all tag interactions may be stored in a relational database system, and those interactions may be modified if someone has database access. The system may implement strict access controls, encryption protocols, and audit logging to protect the integrity of interaction data stored in the relational database, but unlike the immutable ownership records maintained in the cryptographic ledger, the interaction data may potentially be subject to modification by authorized database administrators or through security breaches. This distinction may be important for system transparency, as it may allow organizations to understand which aspects of the authentication system provide absolute immutability versus which components may require additional security oversight and access management protocols.

For businesses, the system provides valuable insights into how consumers interact with their products, where products are being sold, and whether they are moving through authorized distribution channels. This helps brands build direct relationships with consumers, detect counterfeit products, and optimize their supply chain operations.

The primary embodiment comprises a dual-frequency RFID tag system that supports both NFC (e.g., 13.56 MHz) and UHF (e.g., 860-960 MHz) frequencies. Each tag contains at least one cryptographic key that generates a unique signature when accessed, enabling robust authentication verification and preventing cloning attacks. The tags may incorporate tamper detection loops or other elements that permanently record tampering events while maintaining functionality, with specialized tamper detection elements that can detect tampering events. As one example, a tag for use with a beverage container (e.g., a wine bottle) may record events such as a bottle opening or even needle penetration from wine preservation systems. In some embodiments, the system may support alternative tag configurations including dual chip solutions where the identities of two or more chips may be cryptographically associated with each other. This association may enable verification that both chips belong to the same authentic product, with each chip potentially supporting different frequency protocols or security features. The cryptographic association may be established during manufacturing through secure key exchange protocols that create permanent linkages between the chip identities in the product database 908. Additionally, the system may support single frequency chip solutions that operate exclusively on either NFC (13.56 MHz) or UHF (860-960 MHz) protocols while maintaining the same cryptographic security features and tamper detection capabilities. These single frequency implementations may be utilized in specific deployment scenarios where only one communication protocol may be required based on the particular supply chain or consumer interaction requirements of the product category.

Manufacturing integration employs flexible tag association systems that eliminate predetermined production quantity requirements. Unassociated tags from inventory pools are applied during production and registered post-application through scalable programming methods ranging from individual mobile app programming to high-speed batch programming using specialized “printer” devices for automatic label application machinery. Quality control operations utilize handheld RFID reader devices supporting UHF and/or NFC scanning for bulk tag reading, inventory management, and location tracking across multiple operational modes. In high-speed retail or logistics environments, the system may implement ultra-high frequency (UHF) RFID reader systems that may operate at extended ranges up to several meters to rapidly capture tag identities from multiple products simultaneously without requiring individual tag scanning. These UHF reader systems may be deployed at strategic locations such as distribution center entrances, retail stockrooms, or event venues to automatically register product movements and update location data in the cloud database without manual intervention. The UHF scanning capability may enable the system to process hundreds of tagged products per second, with the captured tag identifiers being immediately associated with corresponding product records in the cloud database through secure API connections. This high-throughput scanning capability may significantly reduce inventory processing time while maintaining the same cryptographic security and authentication features available through close-proximity NFC interactions, thereby enabling both efficient supply chain operations and secure consumer authentication through a single integrated tag system.

The consumer interaction platform provides universal access through standard NFC-enabled mobile devices (e.g., smartphones, tablets, etc.). Initial product information displays immediately upon tap via a mobile application, with enhanced features available in some instances. Registered users can claim products using possession-based claiming and/or verified provenance transfer requiring previous owner authorization. The system supports themed collections creation, social sharing capabilities, and maintains interaction history with private and public note functionality.

Supply chain management operations utilize handheld devices operating in configurable modes including quality control (product association and tamper verification), inventory mode (location assignment), packing mode (case association), and shipping/receiving mode (status updates). The system automates inventory updates based on scan context, with quality control mode associating tags with products and verifying tamper status, while inventory mode updates location records without manual data entry.

Data architecture maintains an immutable cryptographic ledger recording all ownership transfers, authentication events, and product interactions providing unchangeable, immutable records throughout the product's lifetime. Geographic tracking captures generalized location data during tag interactions to enable supply chain verification and ensure products appear in authorized distribution channels. Metadata management stores extensive product information including manufacturing details, batch information, authenticity certificates, user-generated content, and comprehensive interaction history.

API integration provides RESTful architecture with comprehensive endpoints for tag registration, product association, and data retrieval supporting both sandbox testing and production environments with proper authentication and error handling. The flexible data models support various tag types (NFC-only, UHF-only, dual-frequency) with appropriate parameter validation and response formatting for seamless integration with existing manufacturing and e-commerce systems.

Authentication verification employs cryptographic signature validation where each tag stores secret keys generating signatures when accessed. The system verifies these signatures against stored records to confirm tag authenticity, with tamper detection maintaining functionality while permanently recording compromise events. Multi-stage authentication supports manufacturer authentication during production, third-party authentication by resellers or auction houses, and consumer authentication throughout the product lifecycle.

The platform architecture includes cloud-based server infrastructure with load balancing and redundancy systems, comprehensive database systems storing product information and user profiles, content management systems enabling dynamic URL management and media asset organization, and analytics engines providing real-time event processing with consumer segmentation algorithms and reporting visualization tools.

FIG. 9 illustrates one possible operating environment through which a platform consistent with embodiments of the present disclosure may be provided. By way of non-limiting example, a _product identification and supply chain management platform 900 may be hosted on, for example, a cloud computing service. In some embodiments, the platform 900 may be hosted on a computing device 500. A user may access platform 900 through a software application and/or hardware device. The software application may be embodied as, for example, but not be limited to, a website, a web application, a desktop application, and a mobile application compatible with the computing device 500.

The platform 900 may be hosted in both a blockchain protocol (“on-chain”) and off of a blockchain protocol (“off-chain”). It should be understood that layers and stages performed by the layers may be either “on-chain” or “off-chain.” The present disclosure anticipates embodiments with variations as to which stages may be performed “on-chain” or “off-chain.” In some embodiments, the system may implement a secure data architecture utilizing relational database records with changes concatenated in an immutable ledger with mathematically verifiable veracity. This approach may enable the system to maintain comprehensive transaction histories while ensuring data integrity through cryptographic validation techniques. The relational database structure may store product information, tag associations, and interaction events in normalized tables with defined relationships, while simultaneously recording all modifications, additions, and state changes as append-only entries in a cryptographically secured ledger. Each database transaction may generate a corresponding ledger entry containing a cryptographic hash of the previous entry, timestamp information, and digital signatures, creating an unbroken chain of verifiable records that cannot be retroactively modified without detection. This hybrid architecture may provide both the query efficiency and relationship modeling capabilities of traditional relational databases alongside the immutable audit trail and tamper-evident properties of blockchain-inspired ledger systems, without requiring the computational overhead of distributed consensus mechanisms.

Accordingly, embodiments of the present disclosure provide a software and hardware platform comprised of a distributed set of computing elements, including, but not limited to:

### A. One or More RFID Tag Devices

The system 900 may include a plurality of RFID tag device 902. Each RFID tag device 902 may comprise a single-and/or dual-frequency radio frequency identification tag configured to support near field communication (NFC) and/or ultra-high frequency (UHF) protocols. As specific examples, the RFID tag device 902 may include an EM4425-v12 or EM4425-v13 chip manufactured chip manufactured by EM Micro Electronics that enables simultaneous NFC operation at 13.56 MHz and UHF operation in the 860-960 MHz frequency range. The tag device 902 may store one or more cryptographic keys. Or a single tag may incorporate two separate IC and have their identities associated to provide the same capabilities, such as an NFC IC like the NXP NTAG 424 in conjunction with a UHF IC such as an Impinj M850. For example, each device may store five cryptographic keys including tagKey1 through tagKey5, though more or fewer cryptographic keys are possible. The cryptographic keys may be stored in non-volatile memory for generating unique authentication signatures when accessed by scanning devices.

The dual-frequency RFID tag device 902 may include secure memory regions configured to store multiple cryptographic keys designated as tagKey1, tagKey2, . . . , tagKeyN, each serving distinct authentication functions within the product authentication system. The cryptographic keys may comprise, as non-limiting examples, 128-bit, 192-bit, or 256-bit symmetric or asymmetric keys generated using cryptographically secure random number generators during tag manufacturing or initialization processes. Each key may be stored in write-protected memory regions that prevent unauthorized modification while enabling read access for internal cryptographic operations.

In some embodiments, each tag key may serve a unique purpose. The tagKey1 may serve as a manufacturer authentication key used to verify the authenticity of the tag and its association with legitimate manufacturing processes. The tagKey2 may function as a product-specific authentication key that validates the association between the tag and specific product metadata stored in the product database 908. The tagKey3 may operate as a supply chain validation key used by authorized handheld scanning devices to verify tag authenticity during inventory and distribution operations. The tagKey4 may serve as a consumer authentication key that enables personalized responses and ownership claiming operations when accessed through consumer RFID readers 906. The tagKey5 may function as a tamper detection key that generates specific signatures when tamper detection circuitry indicates physical compromise of the tag or associated product, enabling the system to distinguish between authentic tampered products and counterfeit items.

The dual-frequency RFID tag device 902 may implement cryptographic signature generation using symmetric encryption algorithms such as Advanced Encryption Standard (AES) in cipher block chaining (CBC) mode or counter (CTR) mode, or alternatively using hash-based message authentication codes (HMAC) with secure hash algorithms such as SHA-256 or SHA-3. The signature generation process may combine multiple input parameters including the tag's unique identifier, current timestamp information, random nonce values, and specific cryptographic keys to produce unique, non-reproducible authentication signatures.

The cryptographic signature generation process may implement specific algorithms such as HMAC-SHA256 where the tag combines its unique identifier with a timestamp and random nonce, then applies the HMAC function using stored secret key tagKey4. For example, the signature may be computed as HMAC-SHA256(tagKey4, UID||timestamp||nonce), where || denotes concatenation. The processing system validates this signature by performing the same computation using the stored tagKey4 and comparing the results. Future versions may implement advanced, asymmetric cryptography such as Elliptic Curve Cryptography.

When accessed by a consumer RFID reader 906, the tag device 902 may generate a cryptographic signature by applying the selected encryption algorithm to a data block comprising the tag's unique identifier concatenated with a timestamp value and a random nonce generated by the tag's internal random number generator. The signature generation may utilize a particular cryptographic key (e.g., tagKey4) designated for consumer authentication scenarios, producing a digital signature that can be validated by the processing system through comparison with an independently computed expected signature using the same algorithm and stored key values.

For supply chain authentication scenarios involving manufacturer RFID readers 904 or handheld scanning devices, the tag device 902 may generate signatures using different key combinations and input parameters appropriate to the scanning context. The signature generation process may automatically select appropriate keys based on the type of reader detected, communication protocol used, or specific commands received during the authentication exchange.

The processing system may implement cryptographic signature validation by retrieving stored cryptographic keys associated with the scanned tag's unique identifier from the tag registry module 910 within the product database 908. The validation process may recreate the expected cryptographic signature using the same algorithm, input parameters, and cryptographic keys employed by the tag during signature generation, then perform a bitwise comparison between the received signature and computed expected signature to determine authenticity.

The signature validation process may account for timing variations and communication delays by implementing tolerance windows for timestamp-based signatures, allowing for reasonable clock drift and network latency while maintaining security against replay attacks. The validation system may maintain a database of recently used nonces and timestamps to prevent replay attacks where previously captured signatures are retransmitted by unauthorized parties attempting to impersonate authentic tags.

For enhanced security, the authentication system may implement challenge-response protocols where the processing system generates random challenge values that are transmitted to the tag device 902, which then incorporates the challenge into its signature generation process. This approach ensures that each authentication exchange produces unique signatures that cannot be replayed, even if previous communications are intercepted by malicious parties.

The dual-frequency RFID tag device 902 may comprise an integrated circuit configured to operate simultaneously across multiple radio frequency bands including near field communication (NFC) at 13.56 MHz and ultra-high frequency (UHF) in the 860-960 MHz range. The tag device 902 may include separate antenna structures optimized for each frequency band, with a compact NFC antenna coil configured for close-proximity communication and a dipole or loop antenna structure configured for long-range UHF communication.

The dual-frequency capability may be implemented through a single integrated circuit such as the EM4425-v12 or EM4425-v13 chip manufactured by EM Micro Electronics, which incorporates dual-frequency transceivers, protocol processors, and memory management systems on a single silicon substrate. The integrated circuit may include separate radio frequency front-end circuits for NFC and UHF operation, with automatic frequency detection and protocol switching capabilities that enable seamless operation across both frequency bands without external control signals.

The NFC functionality may operate according to ISO 14443 Type A or Type B standards, enabling communication with standard consumer mobile devices at distances of approximately 1-4 centimeters. The NFC interface may support data transfer rates of 106 kbps, 212 kbps, or 424 kbps depending on device capabilities and environmental conditions. The UHF functionality may operate according to ISO 18000-6C (EPC Class 1 Generation 2) standards, enabling communication with specialized handheld readers at distances up to several meters depending on antenna configuration and transmission power. The 4425 actually implements Type 5, ISO 15693. This communication protocol may provide enhanced read range capabilities compared to other NFC standards, potentially allowing for reading distances up to 10 centimeters depending on reader configuration and environmental conditions. The ISO 15693 implementation may support anti-collision mechanisms that enable simultaneous reading of multiple tags in close proximity, which may be particularly valuable in retail environments where products may be displayed together. The protocol may also offer configurable data rates and encoding options that may optimize performance based on specific deployment scenarios. When operating in this mode, the tag may support both addressed and non-addressed commands, allowing for both targeted communication with specific tags and broadcast commands to all tags within the reader field. This flexibility in the communication protocol may enhance the system's ability to support various authentication and supply chain management use cases while maintaining compatibility with standard NFC-enabled consumer devices.

The dual-frequency RFID tag device 902 may implement frequency coordination mechanisms to prevent interference between NFC and UHF operations when both protocols are active simultaneously. The tag may include internal switching circuits that automatically prioritize NFC communication when a consumer device is detected in close proximity, while maintaining UHF availability for supply chain scanning operations. The coordination system may implement time-division multiplexing where NFC and UHF operations alternate in rapid succession to provide apparent simultaneous operation while avoiding radio frequency interference.

The tag device 902 may include power management circuits that optimize energy harvesting from both NFC and UHF radio frequency fields. The power management system may automatically switch between NFC-derived power for close-proximity operations and UHF-derived power for long-range communications, with internal energy storage capabilities using capacitive or battery-assisted power sources for enhanced performance in challenging radio frequency environments.

The dual-frequency RFID tag device 902 may include non-volatile memory organized into multiple sections including a unique identifier (UID) region, an electronic product code (EPC) region, user memory for application-specific data, and secure memory areas for cryptographic key storage. The memory architecture may provide separate access controls for NFC and UHF interfaces, enabling different data visibility and modification permissions depending on the communication protocol and reader authentication level.

The tag memory may store multiple cryptographic keys, each serving specific authentication functions including manufacturer verification, consumer authentication, supply chain validation, third-party certification, and tamper detection verification. The cryptographic keys may be stored in write-protected memory regions that prevent unauthorized modification while enabling read access for signature generation operations.

The tag device 902 may implement memory segmentation where certain data regions are accessible only through NFC communication for consumer privacy protection, while other regions remain accessible through both NFC and UHF protocols for supply chain operations. The memory organization may include metadata fields for storing product association information, manufacturing batch data, quality control records, and interaction history summaries.

The RFID tag device 902 may incorporate tamper detection circuitry comprising conductive loops that monitor physical integrity of the tag and associated product. For beverage applications, the tag device 902 may include spiral tamper elements configured to detect needle penetration from wine preservation systems. The tamper detection circuitry may maintain tag functionality after compromise while permanently recording suspected tamper events in the tag's memory for subsequent authentication processes.

The RFID tag device 902 may be configured in multiple operational modes including NFC-only mode for consumer interaction, UHF-only mode for supply chain operations, or dual-frequency mode supporting both protocols simultaneously. The tag device 902 may respond to scanning requests by transmitting stored data including one or more of a unique identifier (UID), an electronic product code (EPC), and/or cryptographically signed authentication data generated using the stored secret keys.

The RFID tag device 902 may be physically attached to products during manufacturing processes through adhesive backing, embedded integration, or mechanical fastening methods. The tag device 902 may maintain data integrity and functionality across temperature ranges typical of product storage and distribution environments, including refrigerated storage for beverage applications and ambient storage for consumer goods.

### B. a Manufacturer RFID Reader

A manufacturer RFID reader 904 may comprise a high-performance scanning device configured for integration into manufacturing production lines and quality control operations. The manufacturer RFID reader 904 may support both near field communication (NFC) and ultra-high frequency (UHF) protocols to communicate with dual-frequency RFID tag devices 902 during production processes. The reader 904 may include multiple antenna configurations enabling simultaneous scanning of multiple tags as products move through manufacturing conveyor systems or automated packaging equipment.

The manufacturer RFID reader 904 may operate in various configurable modes including tag programming mode for writing initial data to unassociated tags, quality control mode for verifying tag functionality and tamper status, and batch association mode for linking tags with specific production runs. The reader 904 may communicate with manufacturing execution systems through standard industrial protocols including Ethernet, RS-485, or wireless connectivity to receive production data and transmit scanning results in real-time.

The manufacturer RFID reader 904 may include specialized “printer” functionality enabling high-speed batch programming of tags during automatic label application processes. The reader 904 may write unique identifiers, cryptographic keys, and initial product metadata to tags at production line speeds without requiring manual intervention. The device may validate successful programming operations and reject defective tags to maintain quality control standards. In conventional product authentication systems, the programming and product association of RFID tags may typically occur during tag manufacturing, rather than during product manufacturing, which may create a more streamlined approach during tag application but can be very inefficient from a tag production standpoint due to unknown yields of products to be manufactured. In the proposed embodiment the tag programming as product association steps are split, allowing more flexible application of tags to multiple different products. During the tag manufacturing process, each dual-frequency RFID tag device 902 may be pre-programmed with a unique identifier and cryptographic keys that may remain constant throughout the tag's lifecycle. These pre-manufactured tags may be produced in large quantities and maintained in inventory pools without requiring specific product associations at the time of tag production. Subsequently, during product manufacturing and tag application, the system may simply read the tag's pre-programmed identifier and create the necessary data associations in cloud-based systems through the product database 908, without requiring complex on-site programming operations. This approach may allow manufacturers to maintain pools of pre-programmed tags that can be flexibly applied to products as needed, with the actual product-specific associations happening through database entries rather than physical reprogramming of the tags. The cloud-side association model may enable greater manufacturing flexibility, as production quantities may not need to be predetermined before tag allocation, and may allow for dynamic adjustment of product-tag relationships based on actual production yields and quality control results.

The manufacturer RFID reader 904 may incorporate environmental protection features including IP65 or higher ingress protection ratings for operation in industrial environments with exposure to moisture, dust, and cleaning chemicals common in beverage production facilities. The reader 904 may operate across extended temperature ranges and withstand vibration and electromagnetic interference typical of manufacturing environments.

The manufacturer RFID reader 904 may provide visual and audible feedback indicators to notify operators of successful scans, programming failures, or detected anomalies during production operations. The reader 904 may maintain local data buffering capabilities to ensure continuity of operations during temporary network connectivity interruptions, with automatic synchronization when connectivity is restored.

The manufacturer RFID reader 904 may support flexible tag association workflows that eliminate the need for predetermined production quantities by enabling post-application registration of tags with product metadata. The reader 904 may interface with inventory management systems to automatically update tag allocation records and maintain accurate counts of programmed versus unprogrammed tag inventory.

### C. a Consumer RFID Reader

The Consumer RFID reader 906 may comprise a standard NFC-enabled mobile device such as a smartphone or tablet configured to interact with dual-frequency RFID tag devices 902 through near field communication protocols. The consumer RFID reader 906 may utilize built-in NFC hardware operating at 13.56 MHz to establish communication with RFID tag devices 902 when brought within proximity range of approximately 1-4 centimeters. The reader 906 may operate without requiring specialized hardware modifications or additional accessories, enabling universal access across consumer device platforms.

The consumer RFID reader 906 may execute mobile applications or web browser interfaces that process tag data received from RFID tag devices 902 and communicate with remote processing systems through cellular data networks or WiFi connectivity. The reader 906 may automatically detect NFC tag presence and initiate scanning operations without requiring manual application launch, providing seamless user experience for product authentication and information access.

The consumer RFID reader 906 may receive and process cryptographic signature data transmitted by RFID tag devices 902, forwarding authentication information to remote processing systems for validation against stored cryptographic keys. The reader 906 may display authentication results, product information, and personalized content received from the processing system through intuitive user interfaces optimized for mobile device screens.

The consumer RFID reader 906 may support various interaction modes including quick authentication for immediate product verification, detailed information access through dedicated mobile applications, and social sharing capabilities enabling users to share product experiences with friends and collections. The reader 906 may maintain local caching of frequently accessed product information to enable offline functionality when network connectivity is limited.

The consumer RFID reader 906 may capture and transmit contextual information including approximate geographic location, timestamp data, and user account information to enable personalized responses and supply chain tracking capabilities. The reader 906 may implement privacy controls allowing users to configure data sharing preferences and location tracking settings according to individual privacy requirements.

The consumer RFID reader 906 may support multiple authentication workflows including anonymous scanning for basic product information, authenticated scanning for registered users accessing enhanced features, and ownership claiming processes that establish user relationships with specific products. The reader 906 may provide visual and haptic feedback to confirm successful scanning operations and guide users through available interaction options.

The consumer RFID reader 906 may integrate with device-native features including camera functionality for capturing product images, contact management for sharing product information, and calendar integration for tracking product acquisition dates and special events associated with premium products such as wine collections or luxury goods.

### D. Product Database

Product database 908 may comprise a secure, distributed database system configured to store and manage comprehensive product information, authentication data, and user interaction records for the dual-frequency RFID authentication system. The product database 908 may include a tag registry module 910 configured to maintain records of all RFID tag devices 902 including unique identifiers, cryptographic keys, manufacturing associations, and current status information. The tag registry module 910 may store all cryptographic keys (e.g., tagKey1 through tagKey5) for each registered tag in an encrypted format with appropriate access controls and key rotation capabilities.

The product database 908 may include a product metadata repository 912 configured to store detailed information about physical products associated with RFID tag devices 902. The product metadata repository 912 may maintain manufacturing details, batch information, quality control records, ingredient specifications, aging information for beverage products, any certifications or authenticity documentation provided by manufacturers or third-party authenticators, and/or any additional information associated with the tagged product.

The product database 908 may include an ownership ledger 914 comprising an immutable cryptographic ledger configured to record all ownership transfers, authentication events, and product interactions throughout the product lifecycle. The ownership ledger 914 may maintain unchangeable, immutable records using blockchain or similar distributed ledger technology to ensure data integrity and provide complete audit trails for premium products requiring provenance verification.

The ownership ledger 914 may comprise a distributed immutable data structure implementing cryptographic hashing and digital signature verification to ensure permanent, tamper-proof records of all product ownership events and authentication activities. The ownership ledger 914 may utilize blockchain technology or similar distributed ledger protocols where each transaction block contains cryptographically linked references to previous blocks, creating an unbreakable chain of custody records that cannot be altered or deleted without detection.

The ownership ledger 914 may include a transaction recording module configured to capture and validate ownership transfer events, product claiming activities, authentication scans, and third-party verification processes. The transaction recording module may generate unique transaction identifiers, timestamp all events with cryptographic time-stamping services, and require digital signatures from authorized parties before committing transactions to the immutable ledger structure.

The ownership ledger 914 may include a consensus mechanism configured to validate transaction authenticity across multiple distributed nodes before permanent commitment to the ledger. The consensus mechanism may implement proof-of-authority or similar validation protocols where authorized network participants verify transaction legitimacy, cryptographic signatures, and business rule compliance before allowing ledger updates.

The ownership ledger 914 may include a smart contract execution engine configured to automatically enforce ownership transfer rules, claiming policies, and authentication requirements through programmable contract logic. The smart contract execution engine may validate transfer authorization from current owners, enforce possession-based claiming rules, process verified provenance transfers, and automatically update ownership status upon successful validation.

The ownership ledger 914 may include a provenance tracking system configured to maintain complete ownership history from initial manufacturing through all subsequent transfers, claims, and authentication events. The provenance tracking system may record manufacturer ownership establishment, consumer claiming events, reseller transfers, auction house authentications, and any third-party verification activities with full cryptographic integrity and audit trail capabilities.

The ownership ledger 914 may include a cryptographic verification module configured to validate all ledger entries using digital signatures, hash verification, and/or merkle tree structures to ensure data integrity across the distributed ledger network. The cryptographic verification module may implement SHA-256 or similar cryptographic hashing algorithms, elliptic curve digital signature algorithms (ECDSA), and merkle root validation to detect any unauthorized modifications or corruption attempts.

The ownership ledger 914 may include an access control system configured to manage read and write permissions for different user classes including manufacturers, consumers, resellers, auction houses, and system administrators. The access control system may implement role-based access control (RBAC) with cryptographic key management, multi-signature authorization requirements for sensitive operations, and audit logging of all access attempts and permission changes.

The ownership ledger 914 may include a dispute resolution framework configured to handle ownership conflicts, fraudulent claims, and authentication disputes through cryptographic evidence evaluation and multi-party arbitration processes. The dispute resolution framework may maintain evidence chains, support multi-signature arbitration decisions, and implement automated resolution for common dispute scenarios while preserving complete audit trails.

The ownership ledger 914 may include a compliance monitoring system configured to ensure ledger operations meet regulatory requirements for data retention, privacy protection, and financial record keeping across multiple jurisdictions. The compliance monitoring system may implement data anonymization for privacy compliance, maintain required retention periods for financial records, and generate compliance reports for regulatory audits.

The ownership ledger 914 may include a synchronization protocol configured to maintain consistency across distributed ledger nodes while handling network partitions, node failures, and temporary connectivity issues. The synchronization protocol may implement eventual consistency guarantees, conflict resolution algorithms, and automatic recovery procedures to ensure ledger integrity across the distributed network infrastructure.

The product database 908 may include a user profile system configured to store consumer account information, interaction history, product collections, and privacy preferences. The user profile system may maintain claiming records, social connections, sharing permissions, and personalized content preferences while implementing appropriate data protection measures to comply with privacy regulations across multiple jurisdictions.

The product database 908 may include a supply chain tracking module 916 configured to store location data, distribution records, and chain of custody information captured during product movement through authorized distribution channels. The supply chain tracking module 916 may maintain warehouse locations, shipping records, retail associations, and geographic scanning patterns to enable unauthorized distribution detection and supply chain visibility reporting.

The product database 908 may include an analytics engine configured to process interaction data, generate consumer engagement metrics, analyze distribution patterns, and provide business intelligence reporting for manufacturers and organizational users. The analytics engine may implement real-time event processing, consumer segmentation algorithms, and predictive analytics capabilities while maintaining user privacy through data anonymization and aggregation techniques.

The product database 908 may include a security monitoring system configured to detect and log suspicious activities, cloning attempts, and/or other potential security threats based on scanning patterns and authentication failures. The security monitoring system may maintain threat intelligence databases, implement anomaly detection algorithms, and generate security alerts for administrative review and response.

The product database 908 may include an API management layer configured to provide secure access to database functionality through RESTful endpoints supporting tag registration, product association, authentication validation, and data retrieval operations. The API management layer may implement authentication, rate limiting, parameter validation, and comprehensive error handling to support integration with manufacturing systems, mobile applications, and third-party platforms.

The product database 908 may include a content management system 918 configured to store and deliver multimedia content including product images, videos, marketing materials, and user-generated content associated with specific products or product categories. The content management system 918 may support dynamic URL management, media asset organization, and content delivery optimization for mobile and web-based user interfaces.

The product database 908 may include a backup and recovery system configured to maintain data redundancy, implement disaster recovery procedures, and ensure business continuity through geographically distributed backup storage and automated failover capabilities. The backup and recovery system may provide point-in-time recovery, data integrity verification, and compliance with data retention requirements for regulated industries.

### E. User Interaction Module

The user interaction module 920 may comprise a comprehensive consumer engagement platform configured to manage all aspects of user interaction with authenticated products through dual-frequency RFID tag devices 902. The user interaction module 920 may include a product claiming engine 922 configured to process consumer requests to establish ownership relationships with scanned products. In some embodiments, the product claiming engine 922 may implement a simple possession-based claiming rule, wherein a user with possession of the tagged item (as demonstrated by a successful read or tap of the RFID tag 902) is permitted to assert ownership. In other embodiments, the product claiming engine 922 may implement verified provenance transfer, requiring previous owner authorization and/or a proof of purchase to effect transfer. Automated validation of claiming eligibility may be determined based on current ownership status and configured claiming policies.

The user interaction module 920 may include a collection management system 924 configured to enable users to create, organize, and share themed product collections based on user-defined criteria such as (but not limited to) product categories, brands, vintage years, or personal preferences. The collection management system 924 may support collaborative collection management with multiple user access levels, sharing permissions among user networks, and social features enabling friends to view and contribute to shared collections.

The user interaction module 920 may include a content generation platform 926 configured to manage user-generated content including private notes, public notes, private reviews, public reviews, tasting notes, product ratings, and/or multimedia content associated with specific products. The content generation platform 926 may implement configurable privacy settings allowing users to control content visibility, moderation capabilities for public content, and content association with specific product instances rather than generic product types.

The user interaction module 920 may include a personalization engine configured to generate customized product information responses based on individual user preferences, interaction history, and behavioral patterns. The personalization engine may analyze scanning history to identify user preferences, recommend similar products based on collection patterns, provide personalized content from manufacturers tailored to demonstrated interests, and adapt user interface presentation based on individual usage patterns.

The personalization engine may analyze user scanning patterns to identify preferences such as product categories, price ranges, and interaction frequency. The system may maintain user preference vectors that weigh different product attributes, enabling generation of customized responses that highlight relevant product features, suggest complementary products, or provide targeted promotional content based on demonstrated user interests.

The user interaction module 920 may include a social networking interface configured to enable users to connect with friends, share product experiences, and participate in community discussions around authenticated products. The social networking interface may support friend connections, product sharing with social media integration, community forums organized by product categories, and social proof features showing friend activities and recommendations. In some embodiments the social network interface may facilitate connection of a user account with one or more social networking sites.

The user interaction module 920 may include a notification system configured to deliver timely updates about product authenticity, ownership changes, collection activities, and social interactions through multiple communication channels. The notification system may support push notifications to mobile devices, email notifications for significant events, in-app messaging for social interactions, and customizable notification preferences allowing users to control communication frequency and types.

The user interaction module 920 may include a gamification framework configured to encourage user engagement through achievement systems, loyalty rewards, and interactive challenges related to product authentication and collection building. The gamification framework may implement achievement badges for scanning milestones, loyalty points for authenticated product interactions, leaderboards for collection activities, and special rewards for discovering rare or limited-edition products.

The user interaction module 920 may include a privacy management system configured to handle user privacy preferences, data protection compliance, and consent management across multiple jurisdictions. The privacy management system may implement granular privacy controls for location tracking, data sharing preferences, content visibility settings, and compliance with GDPR, CCPA, and other privacy regulations through automated consent management and data anonymization capabilities.

The user interaction module 920 may include an authentication interface configured to manage user account creation, login processes, and identity verification for enhanced features requiring authenticated access. The authentication interface may support multiple authentication methods including social media login, email verification, biometric authentication on supported devices, and two-factor authentication for high-value product interactions.

The user interaction module 920 may include a feedback collection system configured to gather user input about product experiences, system functionality, and feature requests to support continuous improvement of the platform. The feedback collection system may implement rating systems for products and user experience, structured feedback forms for specific features, sentiment analysis of user-generated content, and feedback aggregation for manufacturer insights and platform development priorities.

### F. Ownership Tracking Module

The ownership tracking module 928 may comprise a comprehensive ownership management system configured to monitor, validate, and coordinate all ownership-related activities across the dual-frequency RFID authentication platform while maintaining seamless integration with the ownership ledger 914. The ownership tracking module 928 may include an ownership validation engine 930 configured to verify current ownership status, validate transfer eligibility, and enforce ownership rules before committing transactions to the ownership ledger 914. The ownership validation engine 930 may query the ownership ledger 914 to retrieve current ownership records, validate user credentials against stored ownership data, and implement business rules for different ownership scenarios including initial manufacturer ownership, consumer claiming, and authorized transfers.

The ownership tracking module 928 may include a transfer authorization system 932 configured to process ownership transfer requests and coordinate with the ownership ledger 914 to ensure secure, authenticated ownership changes. The transfer authorization system 932 may validate transfer requests against current ownership records stored in the ownership ledger 914, require cryptographic signatures from current owners for authorized transfers, implement multi-party authorization for high-value products, and automatically update the ownership ledger 914 upon successful transfer validation through the ownership ledger smart contract execution engine.

The ownership ledger 914 may implement secure cryptographic protocols that require explicit authorization from the current owner before any updates are made to the ownership records stored within the ledger. When ownership transfers or claims are initiated, the system may verify the identity and authorization of the current owner through cryptographic signatures or other secure authentication methods before executing the appropriate updates to the ledger on their behalf. This authorization requirement may serve as a critical security measure that prevents unauthorized ownership changes while maintaining the immutable nature of the ledger, ensuring that all transactions recorded in the ownership ledger 914 represent legitimate transfers that have been properly authenticated and approved by the authorized parties. The authorization process may be integrated with the smart contract execution engine to automatically enforce ownership rules while providing a verifiable audit trail of all approved transactions.

The ownership tracking module 928 may include a claiming arbitration engine configured to resolve ownership disputes and coordinate with the dispute resolution framework within the ownership ledger 914 to maintain ownership integrity. The claiming arbitration engine may detect conflicting ownership claims, gather evidence from the ownership ledger 914's immutable transaction history, implement automated resolution for common dispute scenarios, and coordinate with the ownership ledger 914's multi-signature arbitration processes for complex disputes requiring human intervention.

The ownership tracking module 928 may include a real-time synchronization interface configured to maintain continuous data consistency between the ownership tracking module 928 and the ownership ledger 914 across distributed system components. The real-time synchronization interface may monitor ownership ledger 914 updates through the synchronization protocol, propagate ownership changes to dependent systems in real-time, implement eventual consistency guarantees during network partitions, and coordinate with the ownership ledger 914's consensus mechanism to ensure transaction validity.

The ownership tracking module 928 may include an ownership analytics processor 934 configured to analyze ownership patterns and generate insights while interfacing with the provenance tracking system within the ownership ledger 914. The ownership analytics processor 934 may query historical ownership data from the ownership ledger 914, analyze ownership transfer patterns to detect anomalies, generate ownership reports for manufacturers and consumers, and coordinate with the ownership ledger 914's cryptographic verification module to ensure data integrity during analytical processing.

The ownership tracking module 928 may include a compliance coordination system configured to ensure ownership operations meet regulatory requirements while leveraging the compliance monitoring system within the ownership ledger 914. The compliance coordination system may coordinate with the ownership ledger 914's compliance monitoring system to ensure regulatory compliance, implement data retention policies consistent with ledger requirements, manage cross-jurisdictional ownership rules, and generate compliance reports combining data from both the ownership tracking module 928 and ownership ledger 914.

The ownership tracking module 928 may include an event notification dispatcher configured to generate ownership-related notifications while coordinating with the ownership ledger 914's transaction recording module. The event notification dispatcher may monitor ownership ledger 914 transactions through the transaction recording module, generate notifications for ownership changes, coordinate with user notification preferences, and ensure notification delivery while maintaining privacy compliance through coordination with the ownership ledger 914's access control system.

The ownership tracking module 928 may include a backup coordination system configured to ensure ownership data redundancy while interfacing with the ownership ledger 914's distributed architecture. The backup coordination system may coordinate backup operations with the ownership ledger 914's consensus mechanism, ensure ownership data availability during system failures, implement disaster recovery procedures that maintain consistency with the ownership ledger 914, and coordinate recovery operations with the ownership ledger 914's synchronization protocol.

The ownership tracking module 928 may include an API gateway interface 934 configured to provide secure access to ownership functionality while coordinating with the ownership ledger 914's smart contract execution engine. The API gateway interface 934 may expose ownership operations through RESTful endpoints, coordinate with the ownership ledger 914's smart contract execution engine for automated ownership rule enforcement, implement rate limiting and authentication for ownership-related API calls, and ensure API responses reflect current ownership status from the ownership ledger 914.

The ownership tracking module 928 may include a legacy system integration bridge configured to interface with existing ownership management systems while maintaining consistency with the ownership ledger 914's immutable records. The legacy system integration bridge may synchronize ownership data with existing enterprise systems, coordinate legacy system updates with ownership ledger 914 transactions, implement data migration procedures that preserve ownership history in the ownership ledger 914, and ensure bidirectional data consistency between legacy systems and the ownership ledger 914's provenance tracking system.

### V. Methods for Authenticating Products

The methods described herein may be performed by one or more processing systems, computing devices, or distributed computing environments. The various operations and stages may be performed by the same actor or distributed among multiple actors including servers, mobile devices, handheld scanning devices, and cloud-based processing systems. The stages may be re-arranged, combined, or performed in different sequences while maintaining the functional relationships between operations. Certain operations may be performed concurrently or in parallel processing configurations. The methods may be implemented across multiple geographic locations with data synchronization between distributed system components. Individual operations may be delegated to specialized processing units or subsystems optimized for particular functions such as cryptographic operations, database management, or user interface processing.

Consistent with embodiments of the present disclosure, a method may be performed by at least one of the aforementioned modules. The method may be embodied as, for example, but not limited to, computer instructions, which, when executed, perform the method. The method may provide a comprehensive approach to product authentication and supply chain management by integrating dual-frequency RFID technology with flexible manufacturing processes and consumer engagement capabilities. The method begins by receiving tag data from consumer devices that have scanned dual-frequency RFID tags attached to physical products, where these tags support both near field communication and ultra-high frequency protocols for versatile interaction modes. The processing system extracts unique tag identifiers and cryptographic signature data from the received tag data, then validates tag authenticity by comparing the cryptographic signatures against stored cryptographic keys while simultaneously determining tamper status through analysis of integrated tamper detection circuitry. The method retrieves comprehensive product metadata from secure databases and generates personalized product information responses based on both the retrieved metadata and historical consumer interaction patterns. Additionally, the method incorporates manufacturing flexibility by processing tag registration data from manufacturing systems and associating dual-frequency RFID tags with product manufacturing metadata after physical tag application, eliminating the need for predetermined production quantities and enabling dynamic tag allocation from unassociated tag pools during manufacturing operations.

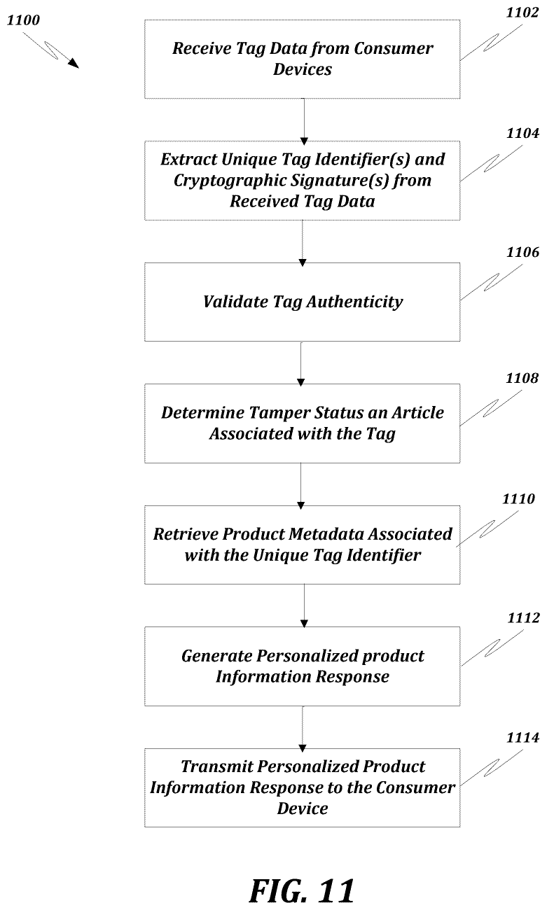

FIG. 11 is a flow chart setting forth the general stages involved in a method 1100 consistent with an embodiment of the disclosure for authenticating physical products using dual-frequency radio frequency identification (RFID) tags. The method 1100 comprises several interconnected stages that enable comprehensive product authentication and supply chain management. Method 1100 may include processing tag registration data from manufacturing systems during product production. For instance, during bottling operations at a distillery, the manufacturing execution system may send batch information, production timestamps, and quality control data to the processing system as bottles move through the production line, enabling real-time association of tags with specific production runs.

The RFID tags may be associated with product manufacturing metadata after physical tag application without requiring predetermined production quantities. In an example implementation, as bottles complete the labeling process where RFID tags are physically applied, the system may automatically associate each tag's UID, and/or EPC and/or TID, or each tag's unique identifier (in any form) with the corresponding bottle's batch information, production date, and quality control results, allowing the distillery to adjust production volumes dynamically without pre-planning exact tag quantities.

Method 1100 may begin stage 1102 where the system receives tag data from consumer devices that have scanned dual-frequency RFID tags attached to physical products. In an example embodiment, a consumer may tap their NFC-enabled smartphone against a wine bottle containing an EM4425 dual-frequency RFID tag, causing the tag to transmit its stored data including unique identifier and cryptographic signature information to the mobile device, which then forwards this data to the processing system via cellular or WiFi connectivity.

In stage 1104, the system may extract unique tag identifiers and cryptographic signature data from the received tag data. For example, the processing system may parse the received NFC data stream to isolate the tag's unique identifier (UID), electronic product code (EPC), and cryptographic signature generated by the tag's internal secret keys, separating this authentication data from any additional metadata or communication protocol overhead.

The system may validate tag authenticity in stage 1106. Validating the tag authenticity may include comparing cryptographic signature data against stored cryptographic keys associated with the unique tag identifier. In a practical implementation, the processing system may retrieve one or more stored secret keys (e.g., tagKey1 through tagKeyN) associated with the scanned tag's UID from the secure database, then compute an expected cryptographic signature using the same algorithm employed by the tag, and compare this computed signature against the signature received from the tag to confirm authenticity and prevent cloning attacks.

In stage 1108, the system may determine a tamper status of the article associated with the tag. In particular, the system may analyze tamper detection circuitry integrated within the tag. For instance, when scanning a wine bottle equipped with a spiral tamper element, the system may analyze the tamper loop's electrical continuity status transmitted by the tag to determine whether the bottle has been opened or compromised by needle penetration from wine preservation systems, with the tag maintaining functionality while permanently recording any tamper events.

At stage 1110, the system may retrieve product metadata associated with the unique tag identifier from a secure database. Metadata may include, for example, an item description, an item manufacturer, any public notes and/or images entered by a user and associated with the item, ownership information associated with the item, a last known item geolocation, and/or any other information associated with the tagged item. In an example scenario, upon successful authentication of a premium whiskey bottle's tag, the system may query the database to retrieve comprehensive product information including distillery details, aging information, batch numbers, alcohol content, tasting notes, and any previously recorded consumer interactions or reviews associated with that specific bottle.

Personalized product information responses may be generated in stage 1112 based on retrieved product metadata and consumer interaction history. For example, the system may combine the retrieved whiskey information with the consumer's previous scanning history, taste preferences, and collection data to generate a customized response highlighting similar products in their collection, recommended food pairings, or exclusive content from the distillery tailored to their demonstrated interests.

At stage 1114, the system may transmit the personalized product information response to the consumer device for display. In practice, this may involve sending formatted JSON data containing product details, images, videos, and interactive elements to the consumer's mobile device, where the proof-it application or web browser displays an engaging interface showing product authenticity confirmation, detailed information, and available interaction options.

The method 1100 may include one or more optional steps, which may enhance the core method functionality. The system may optionally receive bulk scanning data from handheld scanning devices operating in a quality control mode, enabling simultaneous verification of multiple tagged products during manufacturing quality assurance processes. Geographic location tracking may optionally capture scanning locations to analyze distribution patterns and detect unauthorized sales channels. The method may optionally process handheld device scanning data during inventory management operations automatically updating product locations and maintaining real-time inventory counts across warehouse facilities.

In some embodiments, the method 1100 may include processing packing operation data from handheld scanning devices to create hierarchical associations between individual products and shipping containers, enabling container-level tracking throughout distribution networks. The system may optionally detect potential security threats through scanning pattern analysis, identifying suspicious activities that could indicate counterfeiting attempts or unauthorized access.

Third-party authentication capabilities may optionally process authentication requests from authorized resellers and auction houses, validating credentials and associating authentication certificates with product provenance records. Ownership creation and/or transfer functionality may optionally handle transfer authorization requests from current owners, processing secure transfers with cryptographic verification and maintaining complete ownership history.

Consumer engagement features may optionally include collection creation capabilities enabling users to establish themed product collections with collaborative management and sharing permissions.

API integration functionality may optionally process registration requests from manufacturing systems with comprehensive parameter validation and error handling for seamless enterprise integration.

Organizational management capabilities may optionally include pricing configuration processing for managing wholesale and retail pricing structures across multiple locations with synchronized updates between web portals and mobile applications. Enhanced security monitoring may optionally implement advanced threat detection algorithms analyzing scanning patterns and generating security alerts for administrative review.

Supply chain visibility enhancements may optionally provide comprehensive distribution analysis with unauthorized channel detection and stakeholder notifications.

User experience optimization may optionally implement personalization algorithms that adapt product information presentation based on individual user preferences and interaction patterns.

Finally, comprehensive reporting capabilities may optionally generate detailed analytics covering authentication events, consumer engagement metrics, supply chain performance, and organizational financial analysis across the entire product ecosystem.

### VI. Computing Device Architecture

Portions of the invention may be embodied as, for example, but not be limited to, a website, a web application, a desktop application, backend application, and a mobile application compatible with a computing device 500. Any portion of the disclosed systems may include a computing device 500, including the sensor stick 300, hub, cloud server, centralized server, or any other portion of the invention. The computing device 500 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device.

Embodiments herein may be hosted on a centralized server or a cloud computing service. Although methods 700 and 800 have been described to be performed by a computing device 500, it should be understood that, in some embodiments, different operations may be performed by a plurality of the computing devices 500 in operative communication at least one network.

Embodiments of the present disclosure may comprise a system having a central processing unit (CPU) 520, a bus 530, a memory unit 540, a power supply unit (PSU) 550, and one or more Input/Output (I/O) units. The CPU 520 coupled to the memory unit 540 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 9 is a block diagram of a system including computing device 500. Consistent with an embodiment of the disclosure, the aforementioned CPU 520, the bus 530, the memory unit 540, a PSU 550, and the plurality of I/O units 560 may be implemented in a computing device, such as computing device 500 of FIG. 9. Any suitable combination of hardware, software, or firmware may be used to implement the aforementioned units. For example, the CPU 520, the bus 530, and the memory unit 540 may be implemented with computing device 500 or any of other computing devices 500, in combination with computing device 500. The aforementioned system, device, and components are examples and other systems, devices, and components may comprise the aforementioned CPU 520, the bus 530, the memory unit 540, consistent with embodiments of the disclosure.

At least one computing device 500 may be embodied as any of the computing elements illustrated in all of the attached figures, including sensor stick 300, processor 320, local hub, cloud server, web client, or any other element described herein. A computing device 500 does not need to be electronic, nor even have a CPU 520, nor bus 530, nor memory unit 540. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 9, a system consistent with an embodiment of the disclosure may include a computing device, such as computing device 500. In a basic configuration, computing device 500 may include at least one clock module 510, at least one CPU 520, at least one bus 530, and at least one memory unit 540, at least one PSU 550, and at least one I/O 560 module, wherein I/O module may be comprised of, but not limited to a non-volatile storage sub-module 561, a communication sub-module 562, a sensors sub-module 563, and a peripherals sub-module 564.

A system consistent with an embodiment of the disclosure the computing device 500 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 540 or input/output 560). Some embodiments of the clock 510 may include dynamic frequency change, where the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical the CPU cores 521, such as, but not limited to, homogeneous multi-core systems. It is also possible for the plurality of CPU cores 521 to comprise different the CPU cores 521, such as, but not limited to, heterogeneous multi-core systems, big. LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 540, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 500 may employ hardware integrated circuits that store information for immediate use in the computing device 500, know to the person having ordinary skill in the art as primary storage or memory 540. The memory 540 operates at high speed, distinguishing it from the non-volatile storage sub-module 561, which may be referred to as secondary or tertiary storage, which provides slow-to-access information but offers higher capacities at lower cost. The contents contained in memory 540, may be transferred to secondary storage via techniques such as, but not limited to, virtual memory and swap. The memory 540 may be associated with addressable semiconductor memory, such as integrated circuits consisting of silicon-based transistors, used for example as primary storage but also other purposes in the computing device 500. The memory 540 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 541, Static Random-Access Memory (SRAM) 542, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 543, Programmable ROM (PROM) 544, Erasable PROM (EPROM) 545, Electrically Erasable PROM (EEPROM) 546 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 564. The plurality of hardware is used by the at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).

Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using intermediate area in the memory 540. The non-volatile storage sub-module 561 does not lose data when power is removed and may be two orders of magnitude less costly than storage used in memory module, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be said are networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric Current, Electric Potential, Magnetic, and Radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, Weather, Moisture, and Humidity Sensors, Such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 564 comprises ancillary devices uses to put information into and get information out of the computing device 500. There are 3 categories of devices comprising the peripheral sub-module 564, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 564:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 500. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices covert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC).
Input/Output Devices may further comprise, but not be limited to, touchscreens, networking device (e.g., devices disclosed in network 562 sub-module), data storage device (non-volatile storage 561), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### VII. Aspects Of This Disclosure

As described in detail herein, the present disclosure has several aspects, which include, but are not limited to the following:
Aspect 1 includes a device configured to dispense a predetermined amount of liquid, comprising: a bottom cap, the bottom cap having a first opening to receive a liquid and a second opening to measurably release the received liquid; a ball chamber arranged on the bottom cap, the ball chamber having a bottom opening in fluid communication with the second opening of the bottom cap, the ball chamber having a cylindrical cavity arranged to retain a ball bearing and the predetermined amount of liquid, the cylindrical cavity being in fluid communication with the bottom opening, the ball chamber further having a top opening in fluid communication with the cylindrical cavity; a sensor cavity arranged proximate the ball chamber, the sensor cavity configured to retain at least one sensor actuated by the ball bearing and sealed to prevent the liquid from entering the sensor cavity; and a pour spout arranged on the ball chamber, the pour spout being in fluid communication with the top opening of the ball chamber and configured to pour the predetermined amount of liquid.
Aspect 2 includes the device of any preceding aspect, wherein the first opening of the bottom cap is sized to receive the predetermined amount of the liquid.
Aspect 3 includes the device of any preceding aspect, wherein increasing the size of the first opening of the bottom cap decreases the predetermined amount of the liquid.
Aspect 4 includes the device of any preceding aspect, wherein decreasing the size of the first opening of the bottom cap increases the predetermined amount of the liquid.
Aspect 5 includes the device of any preceding aspect, further comprising an air vent disposed proximate the ball chamber, the air vent configured to receive air from an exterior of a liquid dispensing container and direct the received air into the interior of the liquid dispensing container.
Aspect 6 includes the device of any preceding aspect, further comprising a top configured to seat onto a liquid dispensing container.
Aspect 7 includes the device of any preceding aspect, further comprising a sensor stick disposed in the sensor cavity.
Aspect 8 includes the device of any preceding aspect, wherein the sensor stick comprises at least one magnetic sensor configured to detect placement of the ball bearing within the ball chamber, or alternatively, wherein the sensor stick comprises at least one induction sensor configured to detect placement of a metallic ball bearing within the ball chamber.
Aspect 9 includes the device of any preceding aspect, wherein the sensor stick comprises a printed circuit board having printed circuitry thereon and being sized to be retained within the sensor cavity.
Aspect 10 includes the device of any preceding aspect, wherein the sensor stick further comprises at least one processor in operative communication with the printed circuitry.
Aspect 11 includes the device of any preceding aspect, wherein the at least one processor is configured to transmit individual inventory data to a hub device over a wireless communication protocol, and wherein the at least one processor is further configured to receive computer-readable instructions over the wireless communication protocol.
Aspect 12 includes the device of any preceding aspect, further comprising a top configured to seat onto a liquid dispensing container and a cover arranged on the top, the cover being sized to house circuitry and at least one antenna.
Aspect 13 includes the device of any preceding aspect, wherein the top and cover are formed of plastic.
Aspect 14 includes the device of any preceding aspect, further comprising a sealing ring arranged about the ball chamber, the sealing ring arranged to seat and seal within the neck of a liquid dispensing container.
Aspect 15 includes the device of any preceding aspect, wherein the sealing ring is formed of at least one of the following: rubber, cork, and plastic.
Aspect 16 includes a method of automated inventory control of dispensed liquids, the method comprising: receiving inventory data from a customer computing device, the customer computing device being in operative communication with a plurality of inventory tracking devices, each inventory tracking device of the plurality of inventory tracking devices being configured to receive and dispense a predetermined amount of liquid from a liquid dispensing container, and each of the plurality of inventory tracking devices configured to transmit individual inventory data of the associated liquid dispensing container; determining that inventory levels from the inventory data indicate a need for additional product; and assembling at least one purchase order based on determining that the inventory levels from the inventory data indicate the need for additional product.
Aspect 17 includes the method of any preceding aspect, further comprising requesting the inventory data from the customer computing device.
Aspect 18 includes the method of any preceding aspect, wherein receiving the inventory data comprises receiving the inventory data at a scheduled time.
Aspect 19 includes the method of any preceding aspect, wherein receiving the inventory data comprises calculating the inventory data at a hub.
Aspect 20 includes the method of any preceding aspect, wherein receiving the inventory data comprises receiving the inventory data based on demand for additional product.
Aspect 21 includes the method of any preceding aspect, further comprising determining the demand for additional product is based on activity related to pouring liquid from one or more of the plurality of inventory tracking devices.
Aspect 22 includes the method of any preceding aspect, further comprising: transmitting the at least one purchase order to a distributor.
Aspect 23 includes the method of any preceding aspect, further comprising selecting the distributor based on an available inventory for filling the purchase order.
Aspect 24 includes the method of any preceding aspect, wherein the at least one purchase order is a plurality of purchase orders, and the method further comprising: transmitting the plurality of purchase orders to a plurality of distributors.
Aspect 25 includes the method of any preceding aspect, further comprises choosing the plurality of distributors based on available inventory for filling each purchase order of the plurality of purchase orders.
Aspect 26 includes the method of any preceding aspect, further comprising determining if the customer has agreed to share inventory data with third parties.
Aspect 27 includes the method of any preceding aspect, wherein responsive to determining that the customer has agreed to share inventory data with third parties the method comprises: transmitting a summary of the at least one purchase order to an authorized third party.
Aspect 28 includes the method of any preceding aspect, wherein responsive to determining that the customer has agreed to share inventory data with third parties the method comprises: transmitting a summary of the inventory data to an authorized third party.
Aspect 29 includes the method of any preceding aspect, wherein each inventory tracking device of the plurality of inventory tracking devices includes a pour spout for dispensing the predetermined amount of liquid and at least one sensor for detecting the dispensing of the predetermined amount of liquid.
Aspect 30 includes the method of any preceding aspect, wherein each inventory tracking device of the plurality of inventory tracking devices comprises: a bottom cap, the bottom cap having a first opening to receive a liquid and a second opening to measurably release the received liquid; a ball chamber arranged on the bottom cap, the ball chamber having a bottom opening in fluid communication with the second opening of the bottom cap, the ball chamber having a cylindrical cavity arranged to retain a ball bearing and the predetermined amount of liquid, the cylindrical cavity being in fluid communication with the bottom opening, the ball chamber further having a top opening in fluid communication with the cylindrical cavity; a sensor cavity arranged proximate the ball chamber, the sensor cavity configured to retain at least one sensor actuated by the ball bearing and sealed to prevent the liquid from entering the sensor cavity; and a pour spout arranged on the ball chamber, the pour spout being in fluid communication with the top opening of the ball chamber and configured to pour the predetermined amount of liquid.
Aspect 31 includes a method of automated inventory control of dispensed liquids, the method comprising: receiving individual inventory data from a plurality of inventory tracking devices, each inventory tracking device of the plurality of inventory tracking devices being configured to receive and dispense a predetermined amount of liquid from a liquid dispensing container, and each of the plurality of inventory tracking devices configured to transmit individual inventory data of the associated liquid dispensing container; and assembling inventory data for all liquid dispensing containers associated with an inventory tracking device, the inventory data including a volumetric measurement of predicted liquid retained in each liquid dispensing container.
Aspect 32 includes the method of any preceding aspect, further comprising registering individual inventory devices to be associated with individual liquid dispensing containers.
Aspect 33 includes the method of any preceding aspect, wherein registering comprises assigning associated identifying data to an inventory tracking device, the identifying data identifying a particular type of liquid dispensing container associated with the inventory tracking device.
Aspect 34 includes the method of any preceding aspect, further comprising transmitting the assembled inventory data to a centralized server.
Aspect 35 includes the method of any preceding aspect, further comprising transmitting the assembled inventory data to a mobile device.
Aspect 36 includes the method of any preceding aspect, further comprising transmitting the assembled inventory data to a consumer computing apparatus, the consumer computing apparatus configured to display a graphical user interface with a graphical representation of at least a portion of the assembled inventory data.
Aspect 37 includes the method of any preceding aspect, further comprising determining a need to collect inventory data.
Aspect 38 includes the method of any preceding aspect, further comprising receiving updated individual inventory data based on the determined need.
Aspect 39 includes the method of any preceding aspect, further comprising receiving individual inventory data from inventory tracking devices that are active.
Aspect 40 includes the method of any preceding aspect, further comprising determining a need to update software on at least one inventory tracking device.
Aspect 41 includes the method of any preceding aspect, further comprising pushing computer readable instructions to the at least one inventory tracking device based on the determined need.
Aspect 42 includes the method of any preceding aspect, further comprising receiving the computer readable instructions from a centralized server.
Aspect 43 includes the method of any preceding aspect, further comprising determining that an unregistered inventory tracking device is within range of detection.
Aspect 44 includes the method of any preceding aspect, further comprising registering the unregistered inventory tracking device.
Aspect 45 includes the method of any preceding aspect, wherein each inventory tracking device of the plurality of inventory tracking devices comprises: a bottom cap, the bottom cap having a first opening to receive a liquid and a second opening to measurably release the received liquid; a ball chamber arranged on the bottom cap, the ball chamber having a bottom opening in fluid communication with the second opening of the bottom cap, the ball chamber having a cylindrical cavity arranged to retain a ball bearing and the predetermined amount of liquid, the cylindrical cavity being in fluid communication with the bottom opening, the ball chamber further having a top opening in fluid communication with the cylindrical cavity; a sensor cavity arranged proximate the ball chamber, the sensor cavity configured to retain at least one sensor actuated by the ball bearing and sealed to prevent the liquid from entering the sensor cavity; and a pour spout arranged on the ball chamber, the pour spout being in fluid communication with the top opening of the ball chamber and configured to pour the predetermined amount of liquid.
Aspect 46 includes an inventory tracking device, comprising: a bottom cap, the bottom cap having a first opening to receive a liquid and a second opening to measurably release the received liquid; a ball chamber arranged on the bottom cap, the ball chamber having a bottom opening in fluid communication with the second opening of the bottom cap, the ball chamber having a cylindrical cavity arranged to retain a ball bearing and the predetermined amount of liquid, the cylindrical cavity being in fluid communication with the bottom opening, the ball chamber further having a top opening in fluid communication with the cylindrical cavity; a sensor cavity arranged proximate the ball chamber, the sensor cavity configured to retain at least one sensor actuated by the ball bearing and sealed to prevent the liquid from entering the sensor cavity; and a printed circuit board disposed within the sensor cavity, the printed circuit board having the at least one sensor and a processor configured to perform operations, the operations comprising: determining that the at least one sensor has been actuated in response to movement of a liquid dispensing container; and transmitting volumetric data associated with the liquid dispensing container based on the at least one sensor being actuated.
Aspect 47 includes the inventory tracking device of any preceding aspect, wherein the operations further comprise determining an amount of liquid that has been dispensed from a liquid dispensing container based on the at least one sensor being actuated and transmitting the amount to a customer computing device.
Aspect 48 includes the inventory tracking device of any preceding aspect, further comprising receiving computer readable instructions from a customer computing device and applying the computer readable instructions.
Aspect 49 includes the inventory tracking device of any preceding aspect, further comprising sending the volumetric data to a customer computing device.
Aspect 50 includes the inventory tracking device of any preceding aspect, wherein the customer computing device is a hub in communication with a centralized server.
Aspect 51 includes the inventory tracking device of any preceding aspect, wherein the hub is configured to issue purchase orders based on the volumetric data.
Aspect 52 includes the inventory tracking device of any preceding aspect, wherein the at least one sensor is a magnetic sensor configured to detect a change in magnetic flux due to passing of the ball bearing proximate the magnetic sensor, or alternatively, wherein the at least one sensor is an induction sensor configured to detect a metallic ball bearing through electromagnetic induction.
Aspect 53 includes the inventory tracking device of any preceding aspect, wherein the at least one sensor is a proximity sensor configured to detect a proximity of the ball bearing to the at least one sensor.
Aspect 54 includes the inventory tracking device of any preceding aspect, wherein the at least one sensor is an optical sensor configured to detect a passing of the ball bearing in front of the optical sensor.
Aspect 55 includes the inventory tracking device of any preceding aspect, wherein the at least one sensor is a capacitive sensor.
Aspect 56 includes the inventory tracking device of any preceding aspect, wherein determining that the at least one sensor has been actuated comprises sensing a motion of the ball bearing during rotation of the liquid dispensing container.
Aspect 57 includes the inventory tracking device of any preceding aspect, wherein determining the amount of liquid dispensed comprises determining a length of travel of the ball bearing within the ball chamber.
Aspect 58 includes the inventory tracking device of any preceding aspect, wherein determining the amount of liquid dispensed comprises determining if the ball chamber is evacuated.
Aspect 59 includes the inventory tracking device of any preceding aspect, wherein the volumetric data comprises an initial amount of liquid in the liquid dispensing container and a total amount of dispensed liquid from the liquid dispensing container.
Aspect 60 includes the inventory tracking device of any preceding aspect, wherein the inventory tracking device is in operative communication with a hub device over a first network, and wherein the hub device is in operative communication with a centralized server over a second network.
Aspect 61 includes the inventory tracking device of any preceding aspect, and a device configured to dispense a predetermined amount of liquid, comprising: a bottom cap, the bottom cap having a first opening to receive a liquid and a second opening to measurably release the received liquid; a ball chamber arranged on the bottom cap, the ball chamber having a bottom opening in fluid communication with the second opening of the bottom cap, the ball chamber having a cylindrical cavity arranged to retain a ball bearing and the predetermined amount of liquid, the cylindrical cavity being in fluid communication with the bottom opening, the ball chamber further having a top opening in fluid communication with the cylindrical cavity; a sensor cavity arranged proximate the ball chamber, the sensor cavity configured to retain at least one sensor actuated by the ball bearing and sealed to prevent the liquid from entering the sensor cavity; and a pour spout arranged on the ball chamber, the pour spout being in fluid communication with the top opening of the ball chamber and configured to pour the predetermined amount of liquid.
Aspect 62 includes the inventory tracking device of any preceding aspect, wherein the first opening of the bottom cap is sized to receive the predetermined amount of the liquid.
Aspect 63 includes the inventory tracking device of any preceding aspect, wherein increasing the size of the first opening of the bottom cap decreases the predetermined amount of the liquid.
Aspect 64 includes the inventory tracking device of any preceding aspect, wherein decreasing the size of the first opening of the bottom cap increases the predetermined amount of the liquid.
Aspect 65 includes the inventory tracking device of any preceding aspect, further comprising an air vent disposed proximate the ball chamber, the air vent configured to receive air from an exterior of a liquid dispensing container and direct the received air into the interior of the liquid dispensing container.
Aspect 66 includes the inventory tracking device of any preceding aspect, further comprising a top configured to seat onto a liquid dispensing container.
Aspect 67 includes the inventory tracking device of any preceding aspect, further comprising a sensor stick disposed in the sensor cavity.
Aspect 68 includes the inventory tracking device of any preceding aspect, wherein the sensor stick comprises at least one magnetic sensor configured to detect placement of the ball bearing within the ball chamber, or alternatively, wherein the sensor stick comprises at least one induction sensor configured to detect placement of a metallic ball bearing within the ball chamber.
Aspect 69 includes the inventory tracking device of any preceding aspect, wherein the sensor stick comprises a printed circuit board having printed circuitry thereon and being sized to be retained within the sensor cavity.
Aspect 70 includes the inventory tracking device of any preceding aspect, wherein the sensor stick further comprises at least one processor in operative communication with the printed circuitry.
Aspect 71 includes the inventory tracking device of any preceding aspect, wherein the at least one processor is configured to transmit individual inventory data to a hub device over a wireless communication protocol, and wherein the at least one processor is further configured to receive computer-readable instructions over the wireless communication protocol.
Aspect 72 includes the inventory tracking device of any preceding aspect, further comprising a top configured to seat onto a liquid dispensing container and a cover arranged on the top, the cover being sized to house circuitry and at least one antenna.
Aspect 73 includes the inventory tracking device of any preceding aspect, wherein the top and cover are formed of plastic.
Aspect 74 includes the inventory tracking device of any preceding aspect, further comprising a sealing ring arranged about the ball chamber, the sealing ring arranged to seat and seal within the neck of a liquid dispensing container.
Aspect 75 includes the inventory tracking device of any preceding aspect, wherein the sealing ring is formed of at least one of the following: rubber, cork, and plastic.
Aspect 76 includes the inventory tracking device of any preceding aspect, and a method comprising: receiving inventory data from a customer computing device, the customer computing device being in operative communication with a plurality of inventory tracking devices, each inventory tracking device of the plurality of inventory tracking devices being configured to receive and dispense a predetermined amount of liquid from a liquid dispensing container, and each of the plurality of inventory tracking devices configured to transmit individual inventory data of the associated liquid dispensing container; determining that inventory levels from the inventory data indicate a need for additional product; and assembling at least one purchase order based on determining that the inventory levels from the inventory data indicate the need for additional product.
Aspect 77 includes the inventory tracking device and/or method of any preceding aspect, further comprising requesting the inventory data from the customer computing device.
Aspect 78 includes the inventory tracking device and/or method of any preceding aspect, wherein receiving the inventory data comprises receiving the inventory data at a scheduled time.
Aspect 79 includes the inventory tracking device and/or method of any preceding aspect, wherein receiving the inventory data comprises calculating the inventory data at a hub.
Aspect 80 includes the inventory tracking device and/or method of any preceding aspect, wherein receiving the inventory data comprises receiving the inventory data based on demand for additional product.
Aspect 81 includes the inventory tracking device and/or method of any preceding aspect, further comprising determining the demand for additional product is based on activity related to pouring liquid from one or more of the plurality of inventory tracking devices.
Aspect 82 includes the inventory tracking device and/or method of any preceding aspect, further comprising: transmitting the at least one purchase order to a distributor.
Aspect 83 includes the inventory tracking device and/or method of any preceding aspect, further comprising selecting the distributor based on an available inventory for filling the purchase order.
Aspect 84 includes the inventory tracking device and/or method of any preceding aspect, wherein the at least one purchase order is a plurality of purchase orders, and the method further comprising: transmitting the plurality of purchase orders to a plurality of distributors.
Aspect 85 includes the inventory tracking device and/or method of any preceding aspect, further comprises choosing the plurality of distributors based on available inventory for filling each purchase order of the plurality of purchase orders.
Aspect 86 includes the inventory tracking device and/or method of any preceding aspect, further comprising determining if the customer has agreed to share inventory data with third parties.
Aspect 87 includes the inventory tracking device and/or method of any preceding aspect, wherein responsive to determining that the customer has agreed to share inventory data with third parties the method comprises: transmitting a summary of the at least one purchase order to an authorized third party.
Aspect 88 includes the inventory tracking device and/or method of any preceding aspect, wherein responsive to determining that the customer has agreed to share inventory data with third parties the method comprises: transmitting a summary of the inventory data to an authorized third party.
Aspect 89 includes the inventory tracking device and/or method of any preceding aspect, wherein each inventory tracking device of the plurality of inventory tracking devices includes a pour spout for dispensing the predetermined amount of liquid and at least one sensor for detecting the dispensing of the predetermined amount of liquid.
Aspect 90 includes the inventory tracking device and/or method of any preceding aspect, wherein each inventory tracking device of the plurality of inventory tracking devices comprises: a bottom cap, the bottom cap having a first opening to receive a liquid and a second opening to measurably release the received liquid; a ball chamber arranged on the bottom cap, the ball chamber having a bottom opening in fluid communication with the second opening of the bottom cap, the ball chamber having a cylindrical cavity arranged to retain a ball bearing and the predetermined amount of liquid, the cylindrical cavity being in fluid communication with the bottom opening, the ball chamber further having a top opening in fluid communication with the cylindrical cavity; a sensor cavity arranged proximate the ball chamber, the sensor cavity configured to retain at least one sensor actuated by the ball bearing and sealed to prevent the liquid from entering the sensor cavity; and a pour spout arranged on the ball chamber, the pour spout being in fluid communication with the top opening of the ball chamber and configured to pour the predetermined amount of liquid.
Aspect 91 includes the inventory tracking device and/or method of any preceding aspect, and a method of automated inventory control of dispensed liquids, the method comprising: receiving individual inventory data from a plurality of inventory tracking devices, each inventory tracking device of the plurality of inventory tracking devices being configured to receive and dispense a predetermined amount of liquid from a liquid dispensing container, and each of the plurality of inventory tracking devices configured to transmit individual inventory data of the associated liquid dispensing container; and assembling inventory data for all liquid dispensing containers associated with an inventory tracking device, the inventory data including a volumetric measurement of predicted liquid retained in each liquid dispensing container.
Aspect 92 includes the inventory tracking device and/or method of any preceding aspect, further comprising registering individual inventory devices to be associated with individual liquid dispensing containers.
Aspect 93 includes the inventory tracking device and/or method of any preceding aspect, wherein registering comprises assigning associated identifying data to an inventory tracking device, the identifying data identifying a particular type of liquid dispensing container associated with the inventory tracking device.
Aspect 94 includes the inventory tracking device and/or method of any preceding aspect, further comprising transmitting the assembled inventory data to a centralized server.
Aspect 95 includes the inventory tracking device and/or method of any preceding aspect, further comprising transmitting the assembled inventory data to a mobile device.
Aspect 96 includes the inventory tracking device and/or method of any preceding aspect, further comprising transmitting the assembled inventory data to a consumer computing apparatus, the consumer computing apparatus configured to display a graphical user interface with a graphical representation of at least a portion of the assembled inventory data.
Aspect 97 includes the inventory tracking device and/or method of any preceding aspect, further comprising determining a need to collect inventory data.
Aspect 98 includes the inventory tracking device and/or method of any preceding aspect, further comprising receiving updated individual inventory data based on the determined need.
Aspect 99 includes the inventory tracking device and/or method of any preceding aspect, further comprising receiving individual inventory data from inventory tracking devices that are active.
Aspect 100 includes the inventory tracking device and/or method of any preceding aspect, further comprising determining a need to update software on at least one inventory tracking device.
Aspect 101 includes the inventory tracking device and/or method of any preceding aspect, further comprising pushing computer readable instructions to the at least one inventory tracking device based on the determined need.
Aspect 102 includes the inventory tracking device and/or method of any preceding aspect, further comprising receiving the computer readable instructions from a centralized server.
Aspect 103 includes the inventory tracking device and/or method of any preceding aspect, further comprising determining that an unregistered inventory tracking device is within range of detection.

### Aspect 104 Includes the Inventory Tracking Device And/or Method of Any

preceding aspect, further comprising registering the unregistered inventory tracking device.
Aspect 105 includes the inventory tracking device and/or method of any preceding aspect, wherein each inventory tracking device of the plurality of inventory tracking devices comprises: a bottom cap, the bottom cap having a first opening to receive a liquid and a second opening to measurably release the received liquid; a ball chamber arranged on the bottom cap, the ball chamber having a bottom opening in fluid communication with the second opening of the bottom cap, the ball chamber having a cylindrical cavity arranged to retain a ball bearing and the predetermined amount of liquid, the cylindrical cavity being in fluid communication with the bottom opening, the ball chamber further having a top opening in fluid communication with the cylindrical cavity; a sensor cavity arranged proximate the ball chamber, the sensor cavity configured to retain at least one sensor actuated by the ball bearing and sealed to prevent the liquid from entering the sensor cavity; and a pour spout arranged on the ball chamber, the pour spout being in fluid communication with the top opening of the ball chamber and configured to pour the predetermined amount of liquid.
Aspect 106 includes the inventory tracking device and/or method of any preceding aspect, and an inventory tracking device, comprising: a bottom cap, the bottom cap having a first opening to receive a liquid and a second opening to measurably release the received liquid; a ball chamber arranged on the bottom cap, the ball chamber having a bottom opening in fluid communication with the second opening of the bottom cap, the ball chamber having a cylindrical cavity arranged to retain a ball bearing and the predetermined amount of liquid, the cylindrical cavity being in fluid communication with the bottom opening, the ball chamber further having a top opening in fluid communication with the cylindrical cavity; a sensor cavity arranged proximate the ball chamber, the sensor cavity configured to retain at least one sensor actuated by the ball bearing and sealed to prevent the liquid from entering the sensor cavity; and a printed circuit board disposed within the sensor cavity, the printed circuit board having the at least one sensor and a processor configured to perform operations, the operations comprising: determining that the at least one sensor has been actuated in response to movement of a liquid dispensing container; and transmitting volumetric data associated with the liquid dispensing container based on the at least one sensor being actuated.
Aspect 107 includes the inventory tracking device and/or method of any preceding aspect, wherein the operations further comprise determining an amount of liquid that has been dispensed from a liquid dispensing container based on the at least one sensor being actuated and transmitting the amount to a customer computing device.
Aspect 108 includes the inventory tracking device and/or method of any preceding aspect, further comprising receiving computer readable instructions from a customer computing device and applying the computer readable instructions.
Aspect 109 includes the inventory tracking device and/or method of any preceding aspect, further comprising sending the volumetric data to a customer computing device.
Aspect 110 includes the inventory tracking device and/or method of any preceding aspect, wherein the customer computing device is a hub in communication with a centralized server.
Aspect 111 includes the inventory tracking device and/or method of any preceding aspect, wherein the hub is configured to issue purchase orders based on the volumetric data.
Aspect 112 includes the inventory tracking device and/or method of any preceding aspect, wherein the at least one sensor is a magnetic sensor configured to detect a change in magnetic flux due to passing of the ball bearing proximate the magnetic sensor, or alternatively, wherein the at least one sensor is an induction sensor configured to detect a metallic ball bearing through electromagnetic induction.
Aspect 113 includes the inventory tracking device and/or method of any preceding aspect, wherein the at least one sensor is a proximity sensor configured to detect a proximity of the ball bearing to the at least one sensor.
Aspect 114 includes the inventory tracking device and/or method of any preceding aspect, wherein the at least one sensor is an optical sensor configured to detect a passing of the ball bearing in front of the optical sensor.
Aspect 115 includes the inventory tracking device and/or method of any preceding aspect, wherein the at least one sensor is a capacitive sensor.
Aspect 116 includes the inventory tracking device and/or method of any preceding aspect, wherein determining that the at least one sensor has been actuated comprises sensing a motion of the ball bearing during rotation of the liquid dispensing container.
Aspect 117 includes the inventory tracking device and/or method of any preceding aspect, wherein determining the amount of liquid dispensed comprises determining a length of travel of the ball bearing within the ball chamber.
Aspect 118 includes the inventory tracking device and/or method of any preceding aspect, wherein determining the amount of liquid dispensed comprises determining if the ball chamber is evacuated.
Aspect 119 includes the inventory tracking device and/or method of any preceding aspect, wherein the volumetric data comprises an initial amount of liquid in the liquid dispensing container and a total amount of dispensed liquid from the liquid dispensing container.
Aspect 120 includes the inventory tracking device and/or method of any preceding aspect, wherein the inventory tracking device is in operative communication with a hub device over a first network, and wherein the hub device is in operative communication with a centralized server over a second network.
Aspect 121 includes the inventory tracking device and/or method of any preceding aspect, wherein the dual-frequency RFID tag device may implement advanced tamper detection capabilities through specialized circuitry configurations that monitor physical integrity while maintaining operational functionality after tamper events. The tamper detection system may include conductive loops embedded within the tag structure that create closed electrical circuits monitored by the tag's internal processor. When physical tampering occurs, these circuits may be broken or altered, triggering permanent status changes in the tag's memory while allowing continued communication functionality.
Aspect 122 includes the inventory tracking device and/or method of any preceding aspect, wherein for beverage applications, the tamper detection circuitry may include specialized spiral elements configured to detect bottle opening events or needle penetration from wine preservation systems. The spiral elements may be positioned around bottle closures or across bottle surfaces where tampering typically occurs, with electrical continuity monitored through resistance measurements or capacitance changes. When tampering occurs, the electrical properties of these elements may change permanently, allowing the tag to report tamper status during subsequent authentication scans.
Aspect 123 includes the inventory tracking device and/or method of any preceding aspect, wherein the tamper detection system may implement multiple detection zones with independent monitoring circuits, enabling the tag to identify specific types of tampering attempts including cap removal, label peeling, or container puncturing. Each detection zone may maintain separate status flags in the tag's memory, providing detailed tamper information during authentication processes. The tamper detection circuitry may be designed to withstand environmental stresses including temperature variations, humidity exposure, and mechanical vibration without generating false tamper indications.
Aspect 124 includes the inventory tracking device and/or method of any preceding aspect, wherein the tag's tamper detection capabilities may include time-stamping functionality where detected tamper events are recorded with approximate timing information based on internal clock references or scanning history. This temporal data may enable supply chain analysis to determine when in the distribution process tampering occurred, helping identify vulnerable points in the distribution network. The tamper detection system may implement progressive sensitivity levels where initial tampering attempts trigger warning flags while more significant tampering generates permanent tamper indications.
Aspect 125 includes the inventory tracking device and/or method of any preceding aspect, wherein for premium products requiring enhanced security, the tamper detection system may implement redundant detection mechanisms where multiple independent circuits monitor the same physical areas using different detection technologies. This redundancy may reduce false positives while ensuring reliable tamper detection across various environmental conditions and tampering methods. The tamper detection circuitry may be calibrated during manufacturing to account for normal handling stresses, preventing false tamper indications during routine distribution operations.
Aspect 126 includes the inventory tracking device and/or method of any preceding aspect, wherein the consumer interaction module may implement advanced personalization capabilities that adapt product information presentation based on individual user preferences, scanning history, and behavioral patterns. The personalization system may analyze user scanning patterns to identify preferences such as product categories, price ranges, and interaction frequency. The system may maintain user preference vectors that weigh different product attributes, enabling generation of customized responses that highlight relevant product features, suggest complementary products, or provide targeted promotional content based on demonstrated user interests.
Aspect 127 includes the inventory tracking device and/or method of any preceding aspect, wherein the personalization engine may implement machine learning algorithms that continuously refine user profiles based on scanning behavior, collection building patterns, and explicit preference settings. The learning system may identify correlations between product attributes and user engagement levels, automatically adjusting content presentation to emphasize features most likely to resonate with specific users. The personalization capabilities may extend to content formatting where presentation style, information density, and media type selections are customized based on observed user interaction patterns and device characteristics.
Aspect 128 includes the inventory tracking device and/or method of any preceding aspect, wherein for organizational users, the personalization system may implement role-based customization where information presentation is tailored to specific business functions including inventory management, quality control, marketing analysis, and financial oversight. Each role may receive customized dashboards, reports, and alert configurations optimized for their particular operational requirements and decision-making processes. The personalization engine may support A/B testing capabilities where multiple content presentation approaches are systematically evaluated to determine optimal engagement strategies for different user segments.
Aspect 129 includes the inventory tracking device and/or method of any preceding aspect, wherein the personalization system may implement context-aware adaptations where responses consider environmental factors including time of day, geographic location, and seasonal relevance when generating product information displays. The contextual awareness may enable timely promotional content, location-specific recommendations, and seasonally appropriate product suggestions that enhance user engagement and perceived relevance. The personalization engine may support cross-product recommendations where scanning one product generates suggestions for complementary items based on collection patterns observed across the user community.
Aspect 130 includes the inventory tracking device and/or method of any preceding aspect, wherein for premium product categories, the personalization system may implement connoisseur-level content adaptation where information depth and terminology sophistication automatically adjust based on demonstrated user expertise levels. Novice users may receive accessible introductory content while experienced collectors receive detailed technical information appropriate to their knowledge level. The personalization engine may support social influence factors where recommendations incorporate friend activities, expert opinions, and community trends with appropriate weighting based on observed user responsiveness to social signals.
Aspect 131 includes the inventory tracking device and/or method of any preceding aspect, wherein the supply chain tracking module may implement comprehensive geographic analysis capabilities that process location data from scanning events to detect distribution anomalies and unauthorized channel activities. The geographic tracking system may maintain detailed distribution maps showing authorized retailer locations, approved distribution centers, and legitimate supply chain partners to enable comparison against actual scanning locations for unauthorized distribution detection. The geographic analysis may identify products appearing in unauthorized locations, detect gray market activities, and generate alerts when products are scanned outside approved distribution channels or geographic regions. The distribution pattern analysis may implement statistical algorithms that identify normal distribution patterns for specific product categories, detect anomalous geographic clustering that may indicate counterfeiting operations, and track product movement velocities to identify suspicious rapid movement patterns inconsistent with legitimate distribution timelines. The analysis system may generate supply chain visibility reports showing product flow patterns, distribution efficiency metrics, and potential security concerns for manufacturer review. For international distribution, the geographic tracking system may account for customs processing, international shipping delays, and regulatory requirements that affect normal distribution patterns. The system may maintain separate geographic models for different markets and regulatory environments to ensure accurate anomaly detection across diverse international supply chains. The geographic analysis may implement geofencing capabilities where products are assigned authorized distribution territories with automatic alerts generated when products appear outside designated regions.
Aspect 132 includes the inventory tracking device and/or method of any preceding aspect, wherein the geographic tracking system may implement privacy-preserving location generalization where consumer scanning locations are recorded at reduced precision levels sufficient for distribution analysis while protecting individual privacy. The location generalization may implement different precision levels based on user privacy settings, regulatory requirements in specific jurisdictions, and sensitivity of the product category. The geographic analysis may support exclusion zones where certain location types such as private residences receive enhanced privacy protections compared to commercial or public scanning locations.
Aspect 133 includes the inventory tracking device and/or method of any preceding aspect, wherein for products with restricted distribution requirements such as age-controlled beverages, the geographic tracking may implement regulatory compliance monitoring where scanning patterns are analyzed for consistency with local distribution regulations. The compliance monitoring may identify potential regulatory violations including unauthorized cross-border movement, sales in prohibited locations, or distribution through unlicensed channels. The geographic analysis may support authorized distributor verification where scanning locations are compared against registered distributor addresses to confirm legitimate supply chain presence. The manufacturing integration system may implement flexible tag association workflows that eliminate the requirement for predetermined production quantities by maintaining pools of unassociated dual-frequency RFID tag devices that can be dynamically allocated during production operations. The unassociated tag pool may comprise pre-manufactured tags containing unique identifiers and cryptographic keys but lacking specific product associations, enabling manufacturers to apply tags to products and establish associations post-application based on actual production yields and quality control results.
Aspect 134 includes the inventory tracking device and/or method of any preceding aspect, wherein the manufacturer RFID reader may interface with manufacturing execution systems (MES) through standard industrial communication protocols including Ethernet/IP, Modbus TCP, OPC-UA, or proprietary APIs to receive real-time production data including batch information, product specifications, quality control parameters, and production line status. The integration may enable automatic tag association as products move through production lines, with the manufacturer RFID reader capturing manufacturing metadata and associating it with applied tags without requiring manual data entry or predetermined tag-to-product mappings. The flexible association system may support various manufacturing scenarios including continuous production lines where tags are applied and associated in real-time, batch production processes where groups of products are processed simultaneously, and custom production workflows where individual products receive unique configurations and associations. The system may automatically adjust tag allocation based on production line speed, quality control results, and inventory availability to optimize manufacturing efficiency.
Aspect 135 includes the inventory tracking device and/or method of any preceding aspect, wherein the manufacturer RFID reader may implement high-speed tag programming capabilities that write initial product data, manufacturing metadata, and association information to dual-frequency RFID tag devices during production operations. The programming process may utilize specialized “printer” functionality that operates at production line speeds, enabling simultaneous tag programming and label application without disrupting manufacturing workflows or requiring separate programming stations.
Aspect 136 includes the inventory tracking device and/or method of any preceding aspect, wherein the tag programming process may write multiple data elements including unique product identifiers, manufacturing batch numbers, production timestamps, quality control results, ingredient specifications for consumable products, and initial ownership records establishing manufacturer ownership. The programming operation may verify successful data writing through read-back verification, error detection algorithms, and redundant programming attempts to ensure data integrity and tag functionality.
Aspect 137 includes the inventory tracking device and/or method of any preceding aspect, wherein for beverage production applications, the tag association programming process may include product-specific data such as alcohol content, aging information, barrel numbers for aged spirits, vintage dates for wine products, and regulatory compliance information required for distribution and sale. The association programming system may interface with laboratory information management systems to incorporate analytical results, quality control data, and certification information directly into tag memory during production.
Aspect 138 includes the inventory tracking device and/or method of any preceding aspect, wherein the manufacturing integration system may implement automated quality control workflows where handheld scanning devices or fixed-position manufacturer RFID readers verify tag functionality, data integrity, and tamper detection circuitry operation across production batches. The quality control process may include bulk scanning operations that simultaneously verify multiple tags, detect programming failures, identify defective tags, and generate quality control reports linking tag performance to manufacturing batch information.
Aspect 139 includes the inventory tracking device and/or method of any preceding aspect, wherein the quality control system may implement statistical sampling procedures where representative samples from each production batch undergo comprehensive testing including cryptographic signature verification, tamper detection functionality testing, dual-frequency communication verification, and environmental stress testing. Quality control results may be automatically recorded in the product database and associated with specific tags and production batches for traceability and compliance documentation.
Aspect 140 includes the inventory tracking device and/or method of any preceding aspect, wherein batch processing capabilities may enable manufacturers to process entire production runs simultaneously, with the system automatically associating all tags within a batch with common manufacturing parameters while maintaining individual tag identity and product-specific information. The batch processing system may support various batch sizes from small craft production runs to large-scale industrial manufacturing operations, with scalable processing capabilities that adapt to production volume requirements.
Aspect 141 includes the inventory tracking device and/or method of any preceding aspect, wherein the manufacturer RFID reader may integrate with automated production equipment including conveyor systems, packaging machinery, labeling equipment, and robotic handling systems to enable seamless tag application and programming without manual intervention. The integration may utilize industrial sensors, programmable logic controllers, and machine vision systems to coordinate tag application timing, verify proper tag placement, and ensure accurate association with specific products.
Aspect 142 includes the inventory tracking device and/or method of any preceding aspect, wherein the production line integration may implement real-time feedback mechanisms where tag programming results, quality control status, and association success rates are communicated back to production control systems to enable automatic adjustments of line speed, tag application parameters, and quality control thresholds. The feedback system may detect and respond to tag programming failures, communication errors, or quality control issues by automatically rejecting defective products, adjusting programming parameters, or alerting operators to system issues.
Aspect 143 includes the inventory tracking device and/or method of any preceding aspect, wherein for high-speed production environments, the manufacturing integration system may implement predictive tag allocation where the system anticipates tag requirements based on production schedules, historical yield data, and current inventory levels. The predictive allocation may automatically prepare tag programming parameters, pre-stage unassociated tags for specific production runs, and optimize tag inventory management to prevent production delays due to tag shortages.
Aspect 144 includes the inventory tracking device and/or method of any preceding aspect, wherein the API gateway interface may provide comprehensive integration capabilities for enterprise systems through standardized RESTful architecture with robust authentication, error handling, and data validation mechanisms. The API system may implement OAuth 2.0 or similar authentication protocols with role-based access controls that restrict endpoint access based on client credentials, organizational roles, and specific permissions. Each API client may receive unique authentication credentials with appropriate access scopes limiting operations to authorized endpoints and data resources.
Aspect 145 includes the inventory tracking device and/or method of any preceding aspect, wherein the API architecture may include comprehensive endpoint documentation using OpenAPI/Swagger specifications that detail available operations, required parameters, response formats, and error codes. The documentation may include code samples in multiple programming languages, interactive testing capabilities, and implementation guidelines for common integration scenarios. The API system may provide separate sandbox and production environments enabling clients to develop and test integrations without affecting live data. The API endpoints may support various tag registration operations including individual tag registration for small-scale operations, batch registration for high-volume manufacturing, and flexible association workflows that support post-application product linking. The registration endpoints may implement comprehensive parameter validation ensuring required fields are present, data formats are correct, and business rules are satisfied before processing registration requests. For product association operations, the API may provide endpoints supporting different association models including one-to-one mappings between tags and products, hierarchical associations for packaging relationships, and batch associations for production runs. The association endpoints may validate product metadata against configured templates, ensure required regulatory information is present for specific product categories, and verify authorization credentials before establishing associations.
Aspect 146 includes the inventory tracking device and/or method of any preceding aspect, wherein the API gateway may provide comprehensive error handling with standardized HTTP status codes, detailed error messages, and structured error response formats that enable clients to programmatically handle various error conditions. Error responses may include specific error codes, human-readable descriptions, suggested remediation actions, and correlation identifiers for support purposes. The system may implement retry mechanisms with exponential backoff for transient errors and provide clear guidance on which errors are retryable versus permanent failures. For data retrieval operations, the API may implement flexible query parameters enabling filtered access to product information, authentication records, and supply chain data based on client requirements and authorization levels. The query capabilities may support pagination for large result sets, field selection for bandwidth optimization, and sorting options for ordered results. The API may implement caching mechanisms for frequently accessed data to improve performance and reduce system load during peak usage periods. The API system may support webhook notifications enabling clients to receive real-time updates when significant events occur including authentication scans, ownership transfers, tamper detections, or supply chain movements. The webhook system may implement retry logic for failed deliveries, signature verification to ensure notification authenticity, and configuration options for notification content and delivery frequency. For enterprise integration scenarios, the API may provide bulk operation endpoints supporting high-volume data processing requirements including mass product registration, inventory reconciliation, and distribution updates. The bulk operations may implement asynchronous processing models with job status tracking, partial success handling, and detailed operation reports documenting processed items and encountered issues.
Aspect 147 includes the inventory tracking device and/or method of any preceding aspect, wherein the API system may implement comprehensive rate limiting and throttling mechanisms to prevent abuse and ensure system stability across multiple concurrent clients. Rate limiting may be applied per client, per endpoint, and per time window with configurable limits based on client subscription levels, system capacity, and operational requirements. The system may provide rate limit headers in API responses indicating current usage, remaining capacity, and reset times to enable clients to optimize request patterns and avoid throttling. For security operations, the API may implement advanced threat detection monitoring API traffic patterns for suspicious activities including unauthorized access attempts, unusual query patterns, or potential data harvesting operations. The security monitoring may automatically adjust rate limits, implement temporary blocks, or require additional authentication for suspicious clients while maintaining detailed audit logs of security events.
Aspect 148 includes the inventory tracking device and/or method of any preceding aspect, wherein the content management system may provide comprehensive multimedia asset organization capabilities supporting various content types associated with authenticated products and consumer engagement activities. The content system may maintain structured repositories for product images, marketing videos, technical documentation, user-generated media, and interactive content with appropriate metadata tagging, version control, and access permissions for each asset type.
Aspect 149 includes the inventory tracking device and/or method of any preceding aspect, wherein the content organization may implement hierarchical categorization where assets are organized by product categories, brands, collections, campaigns, and content types enabling efficient content retrieval for specific presentation contexts. The categorization system may support multiple simultaneous classification schemes allowing content to appear in various organizational views based on access context and user requirements.
Aspect 150 includes the inventory tracking device and/or method of any preceding aspect, wherein for product imagery, the content system may maintain multiple resolution variants optimized for different display contexts including thumbnail previews, mobile device displays, high-resolution web presentations, and print-quality marketing materials. The image processing may automatically generate required variants from master assets, apply consistent cropping and formatting rules, and optimize file formats for delivery performance across different platforms.
Aspect 151 includes the inventory tracking device and/or method of any preceding aspect, wherein the content management system may implement dynamic URL generation creating secure, time-limited access links for content delivery that prevent unauthorized distribution while enabling efficient content caching and delivery through content delivery networks. The URL generation may incorporate access controls based on user authentication, geographic restrictions, and content sensitivity levels to ensure appropriate content protection.
Aspect 152 includes the inventory tracking device and/or method of any preceding aspect, wherein for marketing campaigns, the content system may support scheduled content releases where new assets become available at specific dates and times coordinated with product launches, promotional events, or seasonal campaigns. The scheduling capabilities may include preview modes for content verification before public release, automatic publication workflows, and coordinated multi-channel distribution across web, mobile, and social platforms.
Aspect 153 includes the inventory tracking device and/or method of any preceding aspect, wherein the content management system may implement personalization capabilities where content selection and presentation adapt based on user profiles, interaction history, and contextual factors. The personalization may dynamically assemble content collections highlighting relevant product features, complementary items, or promotional offers based on demonstrated user interests and current marketing priorities.
Aspect 154 includes the inventory tracking device and/or method of any preceding aspect, wherein for user-generated content, the content system may implement moderation workflows where submitted materials undergo review processes before public availability. The moderation may include automated filtering for inappropriate content, manual review queues for human verification, and configurable approval rules based on content type, user reputation, and sensitivity thresholds.
Aspect 155 includes the inventory tracking device and/or method of any preceding aspect, wherein the content management system may support localization capabilities where content assets are managed in multiple languages and regional variants with appropriate metadata indicating language, region, and cultural context. The localization may include translation management workflows, region-specific asset variants, and automatic content selection based on user language preferences and geographic location.
Aspect 156 includes the inventory tracking device and/or method of any preceding aspect, wherein for interactive content types including augmented reality experiences, virtual product demonstrations, and gamified engagement activities, the content system may maintain component libraries, interaction scripts, and configuration parameters enabling dynamic assembly of personalized interactive experiences. The interactive content management may support A/B testing frameworks where multiple experience variants are systematically evaluated for engagement effectiveness.
Aspect 157 includes the inventory tracking device and/or method of any preceding aspect, wherein the content management system may implement comprehensive analytics tracking content performance metrics including view counts, engagement duration, conversion impact, and sharing frequency across different channels and user segments. The analytics may identify high-performing content patterns, detect underperforming assets requiring optimization, and generate content strategy recommendations based on observed engagement patterns.
Aspect 158 includes the inventory tracking device and/or method of any preceding aspect, wherein for regulatory compliance, the content system may maintain approval workflows where content undergoes legal review before publication, with appropriate tracking of approval status, required disclaimers, and regulatory certifications for regulated product categories. The compliance management may include automatic application of required notices, age verification gates for restricted content, and geographic distribution controls based on regional regulatory requirements.
Aspect 159 includes the inventory tracking device and/or method of any preceding aspect, wherein the content management system may support digital rights management capabilities protecting intellectual property through watermarking, access controls, and usage tracking for sensitive or valuable content assets. The rights management may implement different protection levels based on content value, distribution context, and licensing agreements while maintaining detailed usage logs for royalty calculations and compliance verification.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method for authenticating physical products using dual-frequency radio frequency identification tags, the method performed by a processing system and comprising:
receiving, from a consumer device, tag data obtained by scanning at least one RFID tag, the at least one RFID tag comprising one of the following:
a dual-frequency RFID tag attached to a physical product, the dual-frequency RFID tag supporting both near field communication and ultra-high frequency protocols, and a first near field communication tag and a second ultra-high frequency tag;
extracting a unique tag identifier and cryptographic signature data from the received tag data;
validating authenticity of the at least one RFID tag by comparing the cryptographic signature data against stored cryptographic keys associated with the unique tag identifier;
determining tamper status of the at least one RFID tag by analyzing tamper detection circuitry integrated within the tag;
retrieving product metadata associated with the unique tag identifier from a secure database;
generating a personalized product information response based on the retrieved product metadata and consumer interaction history; and
transmitting the personalized product information response to the consumer device for display.

2. The method of claim 1, further comprising:
receiving a product claiming request from the consumer device;
determining claiming eligibility based on current ownership status and claiming policy configuration;
updating ownership records in an immutable cryptographic ledger upon successful claiming; and
generating ownership confirmation data for transmission to the consumer device.

3. The method of claim 2, further comprising:
receiving user-generated content associated with the physical product from the consumer device;
validating content permissions based on privacy settings and user authorization levels;
storing the user-generated content in association with the unique tag identifier; and
making the user-generated content available to subsequent users based on configured sharing permissions.

4. The method of claim 1, further comprising:
receiving tag registration data from a manufacturing system during product production;
associating the at least one RFID tag with product manufacturing metadata after physical tag application without requiring predetermined production quantities;
establishing initial ownership records for the manufacturing entity; and
enabling flexible tag allocation from unassociated tag pools during manufacturing operations.

5. The method of claim 4, further comprising:
receiving bulk scanning data from handheld scanning devices operating in quality control mode;
verifying functionality of multiple at least one RFID tags simultaneously across product batches;
detecting tamper status for batches of tagged products during manufacturing quality control; and
generating quality control reports linking tag functionality to manufacturing batch information.

6. The method of claim 1, further comprising:
receiving geographic location data associated with tag scanning events;
analyzing supply chain distribution patterns based on accumulated location data;
detecting unauthorized distribution channels by comparing actual locations against authorized distributor networks; and
generating supply chain visibility alerts for manufacturer oversight.

7. The method of claim 1, further comprising:
receiving handheld device scanning data during inventory management operations;
updating product location records based on scanning context and operational mode configuration;
maintaining real-time inventory counts across multiple storage locations; and
synchronizing inventory data between handheld devices and central database systems.

8. The method of claim 1, further comprising:
receiving packing operation data from handheld scanning devices;
creating hierarchical associations between individual product tags and shipping container tags;
establishing container-level tracking records linking multiple products for distribution; and
enabling automated status updates throughout distribution networks based on container scanning events.

9. A system for product authentication and supply chain management comprising:
a processing system configured to communicate with at least one RFID tag, the at least one RFID tag comprising one of the following:
a dual-frequency RFID tag attached to a physical product, the dual-frequency RFID tag supporting both near field communication and ultra-high frequency protocols, and
a first near field communication tag and a second ultra-high frequency tag;
a secure database storing cryptographic keys and product metadata associated with unique tag identifiers;
handheld scanning devices configured to operate in multiple modes including quality control, inventory management, and packing operations; and
wherein the processing system is configured to receive tag data from consumer devices and handheld scanning devices, validate tag authenticity using cryptographic signature verification, determine tamper status through integrated tamper detection circuitry analysis, and generate personalized responses based on user context and product metadata.

10. The system of claim 9, wherein the handheld scanning devices are configured to:
perform bulk scanning operations across multiple at least one RFID tags simultaneously;
operate in configurable modes including quality control verification, inventory location updates, and shipping container association;
synchronize scanning data with the secure database in real-time; and
generate operational reports based on scanning context and device configuration.

11. The system of claim 9, further comprising:
an immutable cryptographic ledger configured to record ownership transfers, authentication events, and product interactions;
API endpoints configured to receive tag registration requests from manufacturing systems and process multiple tag type configurations;
geographic tracking capabilities configured to analyze supply chain distribution patterns and detect unauthorized distribution channels; and
user management functionality configured to handle product claiming, collection creation, and collaborative sharing permissions.

12. The system of claim 9, wherein the at least one RFID tag comprises:
cryptographic signature generation capabilities using stored secret keys;
tamper detection circuitry configured to detect physical compromise while maintaining tag functionality;
support for NFC-only, UHF-only, and dual-frequency operational configurations; and
unique identifier storage enabling association with product metadata and manufacturing information.

13. The system of claim 9, further comprising:
consumer mobile applications configured to scan at least one RFID tag and display personalized product information;
web portals configured to provide organizational management interfaces for pricing configuration and inventory oversight;
third-party authentication interfaces configured to process authentication requests from resellers and auction houses; and
security monitoring capabilities configured to detect cloning attempts and suspicious scanning patterns.

14. A non-transitory computer-readable medium storing instructions that, when executed by a processing system, cause the processing system to perform operations comprising:
receiving tag data from at least one RFID tag attached to physical products, the at least one RFID tag comprising one of the following:
a dual-frequency RFID tag attached to a physical product, the dual-frequency RFID tag supporting both near field communication and ultra-high frequency protocols, and
a first near field communication tag and a second ultra-high frequency tag;
validating tag authenticity through cryptographic signature verification using stored secret keys;
determining tamper status through analysis of integrated tamper detection circuitry;
managing product ownership records in an immutable cryptographic ledger;
processing handheld device scanning data for quality control, inventory management, and packing operations;
generating personalized consumer responses based on product metadata and interaction history; and
maintaining supply chain visibility through geographic tracking and distribution pattern analysis.

15. The non-transitory computer-readable medium of claim 14, wherein the operations further comprise:
processing API requests for tag registration from manufacturing systems supporting multiple tag type configurations;
managing user-generated content with configurable privacy settings and sharing permissions;
creating themed product collections with collaborative management capabilities;
processing third-party authentication requests from authorized resellers and auction houses; and
generating security alerts based on scanning pattern anomalies and cryptographic validation failures.

16. The method of claim 1, further comprising:
receiving ownership transfer authorization requests from current product owners;
validating transfer eligibility through secure authentication protocols;
processing authorized ownership transfers with cryptographic verification; and
maintaining complete ownership history throughout product lifecycle in the immutable ledger.

17. The method of claim 1, further comprising:
detecting potential security threats through scanning pattern analysis;
identifying cloning attempts via cryptographic signature validation failures;
logging suspicious activities for security analysis; and
updating threat intelligence databases with identified attack patterns.

18. The method of claim 4, further comprising:
receiving third-party authentication requests from authorized resellers and auction houses;
validating third-party credentials and authorization levels;
associating authentication certificates with product provenance records; and
maintaining multi-party authentication history throughout product lifecycle.

19. The method of claim 2, further comprising:
receiving collection creation requests from authenticated users;
establishing themed product collections based on user-defined criteria;
configuring sharing permissions for collections among user networks; and
enabling collaborative collection management with multiple user access levels.

20. The method of claim 9, further comprising:
receiving pricing configuration data from organizational management systems;
managing wholesale and retail pricing structures for different user access levels;
synchronizing pricing data between web portals and mobile applications; and
generating comprehensive reports for organizational financial analysis and supply chain oversight.
